(19) United States
(12) Patent Application Publication
(10) Pub. No.: US 2020/0377126 A1
(43) Pub. Date: Dec. 3, 2020

(54) INFORMATION OUTPUT CONTROL DEVICE AND INFORMATION OUTPUT CONTROL METHOD

(71) Applicant: Mitsubishi Electric Corporation, Tokyo (JP)

(72) Inventors: Naohiko OBATA, Tokyo (JP); Yoshitaka NAKAMURA, Tokyo (JP); Tadashi MIYAHARA, Tokyo (JP); Mitsuo SHIMOTANI, Tokyo (JP); Yoshinori UENO, Tokyo (JP); Hisanori YAMADA, Tokyo (JP)

(73) Assignee: Mitsubishi Electric Corporation, Tokyo (JP)

(21) Appl. No.: 16/326,641

(22) PCT Filed: Oct. 3, 2016
(86) PCT No.: PCT/JP2016/079260

§ 371 Date: Feb. 19, 2019

(51) Int. Cl. B60W 60/00; B60W 50/08

(52) U.S. Cl. CPC B60W 60/0055; B60W 60/0018; B60W 2050/143; B60W 50/082; B60W 60/0059

(57) ABSTRACT

A plurality of sections in a planned travel route include a first basic section for a first automatic driving level, a second basic section for a second automatic driving level lower than the first automatic driving level, and a change preparation section and a main section in the first basic section. An information output control device controls an information output system so as to perform information output in accordance with an output structure allowed in a current section, among a plurality of types of output structures each determined by a combination of output information, an output format, and an output destination device. Allowed output structures for the change preparation section include part of not-allowed output structures for the main section and also include at least part of allowed output structures for the second basic section.

### TECHNICAL FIELD

The present invention relates to a technique for controlling an information output system used for a vehicle capable of traveling by automatic driving.

### BACKGROUND ART

Patent Document 1 discloses a technique for smoothly changing a speed of a vehicle, in switching from automatic driving to manual driving, from a speed during the automatic driving to that required by a driver. Specifically, a CPU sets an adjustment section at a predetermined distance before a switching start point where switching from the automatic driving to the manual driving starts, in a traveling direction. The CPU estimates, in the adjustment section, a traveling output which a driver requires of the vehicle after the switching to the manual driving, on the basis of a state of drive operation performed by the driver within the adjustment section. Further, in the adjustment section, the automatic driving is performed like before the adjustment section. The CPU controls an actual traveling output of the vehicle in an output section after the switching start point so as to become the above estimated traveling output.

Herein, the CPU sets a start point of the adjustment section as a switching notification point, and when the vehicle reaches the switching notification point, the CPU notifies the driver of the switching from the automatic driving to the manual driving. Specifically, when the vehicle reaches the switching notification point, the CPU informs the driver by voice as follows, “Automatic driving will be canceled 10 seconds later. Prepare to drive”. After that, the CPU counts down the remaining time until the switching from the automatic driving to the manual driving starts, by voice and display.

### PRIOR ART DOCUMENTS

### Patent Documents

[Patent Document 1] Japanese Patent Application Laid-Open No. 2015-182525

### SUMMARY

### Problem to be Solved by the Invention

It is thought that by the technique disclosed in Patent Document 1, the driver can smoothly start a drive operation when the automatic driving is switched to the manual driving. Further, it is thought that by providing the adjustment section, and moreover by notifying the presence of the adjustment section, the driver can be got in psychological readiness for the switching to the manual driving during the adjustment section. The adjustment section in Patent Document 1 is, however, only provided from the viewpoint of driving operability.

It is an object of the present invention to provide a technique for controlling outputs of various information on a vehicle in accordance with an automatic driving level and enabling a driver to bodily sense information output after change of the automatic driving level, before the change of the automatic driving level.

### Means to Solve the Problem

The present invention is intended for an information output control device which controls an information output system used for a vehicle capable of traveling by automatic driving. The information output control device includes a section management unit for determining a current section in which the vehicle is present among a plurality of sections set for a planned travel route of the vehicle. The plurality of sections include a first basic section in which the vehicle is planned to travel at a first automatic driving level, a second basic section in which the vehicle is planned to travel at a second automatic driving level lower than the first automatic driving level, a change preparation section which is set when the second basic section is continuous to the first basic section, starting during the first basic section and ending at the start of the second basic section, and a main section which is a section of the first basic section except the change preparation section. The information output control device further includes an output control unit for controlling the information output system so as to perform information output to a user, in accordance with an output structure allowed in the current section, among a plurality of types of output structures determined by a combination of output information, an output format, and an output destination device included in the information output system. Allowed output structures for the change preparation section include part of not-allowed output structures for the main section and also include at least part of allowed output structures for the second basic section.

### Effects of the Invention

According to the information output control device of the present invention, part or all of the allowed output structures for the second basic section, i.e., the second automatic driving level are applied in the change preparation section before the second basic section. For this reason, the driver can bodily sense the information output after the automatic driving level decreases, before the automatic driving level decreases. Therefore, the driver can become accustomed to the car environment after the automatic driving level decreases, and can smoothly adapt to a decrease in the automatic driving level.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing an information output control device in accordance with a first preferred embodiment and an application example thereof;

FIG. 2 is a table showing exemplary automatic driving levels;

FIG. 3 is a view showing a change preparation section;

FIG. 4 is a table showing output structure information in accordance with the first preferred embodiment;

FIG. 5 is a table showing the output structure information in accordance with the first preferred embodiment;

FIG. 6 is a transition diagram of the automatic driving levels in accordance with the first preferred embodiment;

FIG. 7 is a view showing exemplary information outputs in accordance with the first preferred embodiment;

FIG. 8 is a table showing exemplary information outputs in accordance with the first preferred embodiment;

FIG. 9 is a hardware constitution diagram of the information output control device in accordance with the first preferred embodiment;

FIG. 10 is a flowchart showing an operation of the information output control device in accordance with the first preferred embodiment;

FIG. 11 is a flowchart showing the operation of the information output control device in accordance with the first preferred embodiment;

FIG. 12 is a view in which a comparative example is added to FIG. 7;

FIG. 13 is a table showing exemplary information outputs in accordance with a second preferred embodiment;

FIG. 14 is a block diagram showing an application example of an information output control device in accordance with a third preferred embodiment;

FIG. 15 is a block diagram showing an information output control device in accordance with a fourth preferred embodiment and an application example thereof;

FIG. 16 is a flowchart showing an operation of the information output control device in accordance with the fourth preferred embodiment;

FIG. 17 is a view showing a change preparation section in accordance with the fourth preferred embodiment;

FIG. 18 is a view showing the change preparation section in accordance with the fourth preferred embodiment;

FIG. 19 is a view showing the change preparation section in accordance with the fourth preferred embodiment;

FIG. 20 is a block diagram showing an information output control device in accordance with a fifth preferred embodiment and an application example thereof;

FIG. 21 is a table showing output structure information in accordance with the fifth preferred embodiment;

FIG. 22 is a table showing the output structure information in accordance with the fifth preferred embodiment;

FIG. 23 is a view showing exemplary information output in accordance with the fifth preferred embodiment;

FIG. 24 is a view showing exemplary information output in accordance with the fifth preferred embodiment;

FIG. 25 is a view showing exemplary information output in accordance with the fifth preferred embodiment;

FIG. 26 is a view showing exemplary information output in accordance with the fifth preferred embodiment;

FIG. 27 is a view showing exemplary information output in accordance with the fifth preferred embodiment;

FIG. 28 is a view showing exemplary information output in accordance with the fifth preferred embodiment;

FIG. 29 is a block diagram showing the information output control device in accordance with the fifth preferred embodiment and an application example thereof;

FIG. 30 is a block diagram showing an information output control device in accordance with a sixth preferred embodiment and an application example thereof;

FIG. 31 is a block diagram showing an information output control device in accordance with a seventh preferred embodiment;

FIG. 32 is a block diagram showing another information output control device in accordance with the seventh preferred embodiment;

FIG. 33 is a block diagram showing still another information output control device in accordance with the seventh preferred embodiment; and

FIG. 34 is a block diagram showing yet another information output control device in accordance with the seventh preferred embodiment.

### DESCRIPTION OF EMBODIMENT(S)

### The First Preferred Embodiment

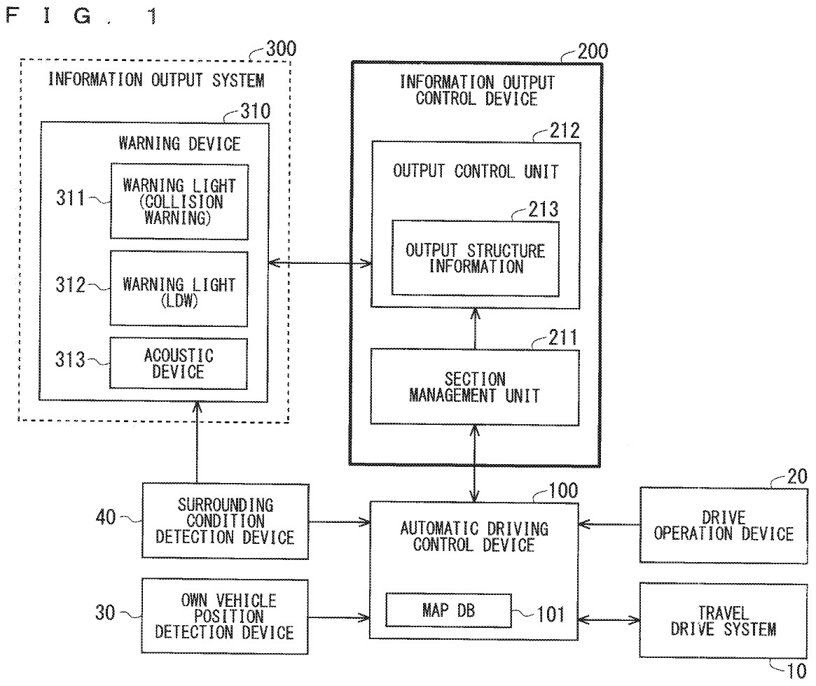

FIG. 1 is a block diagram showing an information output control device 200 in accordance with the first preferred embodiment and an application example of the information output control device 200. The information output control device 200 is a device which controls an information output system 300 used for a vehicle capable of traveling by automatic driving. Herein, it is assumed that the information output control device 200 and the information output system 300 are provided in a vehicle. The vehicle has only to be a moving body. Specifically, the vehicle is not limited by the vehicle model, the driving method, the energy type, or the like, but may be, for example, any one of a gasoline vehicle, an electric vehicle, a hybrid vehicle, and the like. Hereinafter, sometimes, the vehicle to which the information output control device 200 is applied is referred to as an “own vehicle” and vehicles other than the own vehicle is referred to as “other vehicles”.

In FIG. 1, for illustration purpose, shown are an automatic driving control device 100, a travel drive system 10, a drive operation device 20, an own vehicle position detection device 30, and a surrounding condition detection device 40.

The travel drive system 10 is a device for causing the vehicle to travel, and includes an accelerator, a steering gear, and braking device. The travel drive system 10 sometimes includes a device used for travelling of the vehicle, for example, a blinker. The travel drive system 10 is under the control of the automatic driving control device 100. Further, the travel drive system 10 uses various sensors to detect an operating condition of the travel drive system 10 and supplies the automatic driving control device 100 with the detection result. The information is used when the automatic driving control device 100 controls the travel drive system 10.

When control authority of the travel drive system 10, in other words, driving authority of the vehicle is given to the vehicle, the automatic driving control device 100 autonomously controls the travel drive system 10. In consideration of this point, a state in which the vehicle has the driving authority may be expressed as a state in which the automatic driving control device 100 has the driving authority. In contrast to this, when a driver of the vehicle has the driving authority, the driver operates the drive operation device 20 to control the travel drive system 10.

The drive operation device 20 is a device used by the driver to drive the vehicle. The drive operation device 20 includes devices used by the driver to operate the travel drive system 10, for example, a steering wheel, an accelerator pedal, and a brake pedal. Further, the drive operation device 20 includes devices used by the driver to input instructions relating to driving to the vehicle, for example, a handle lever and a blinker lever. Operation contents performed by the drive operation device 20 are inputted to the automatic driving control device 100. When the driver has the driving authority, the automatic driving control device 100 controls the travel drive system 10 on the basis of the operation contents.

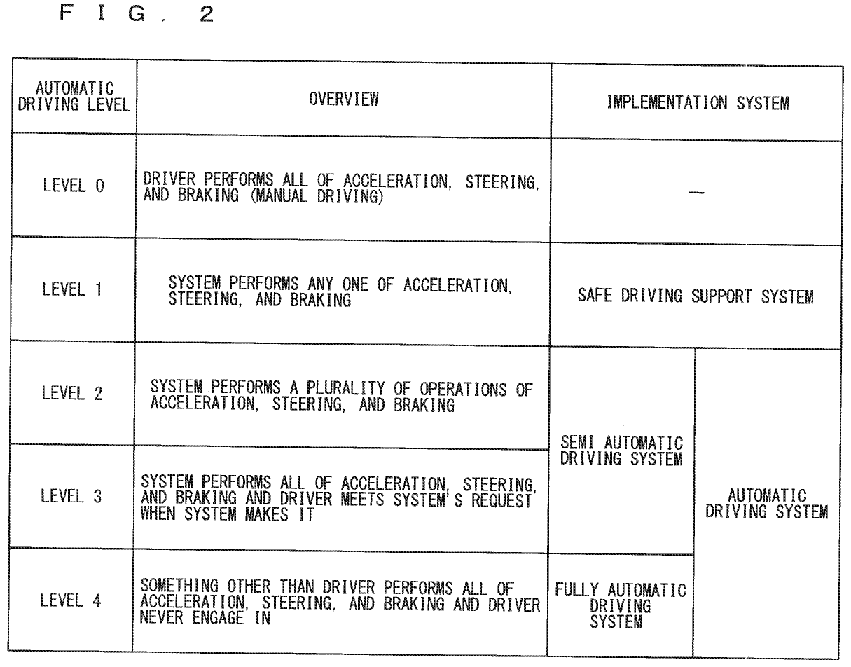

Herein, FIG. 2 shows exemplary automatic driving levels. The automatic driving level is sometimes referred to as an automation level. In FIG. 2, the automatic driving levels are classified into five levels. Level 0 refers to a state in which a driver performs all of acceleration, steering, and braking, i.e., a state of manual driving.

Levels 1 to 4 rely on the “Research and Development Project on Automated Driving System” of the “Cross-ministerial Strategic Innovation Promotion Program (SIP)” announced on May 21, 2015 by the Cabinet Office of Japan.

Level 1: a state in which a system performs any one of acceleration, steering, and braking

Level 2: a state in which a system performs a plurality of operations of acceleration, steering, and braking

Level 3: a state in which a system performs all of acceleration, steering, and braking and a driver meets system's request when the system makes it

Level 4: a state in which something other than a driver performs all of acceleration, steering, and braking and the driver never engage in

Further, the above-described “system” refers to a mechanism in which a vehicle determines a road environment and the like from information acquired by, for example, autonomous sensors and communication and, perform all or part of acceleration, steering, and braking. In FIG. 1, the automatic driving control device 100 and the like correspond to the above-described “system”.

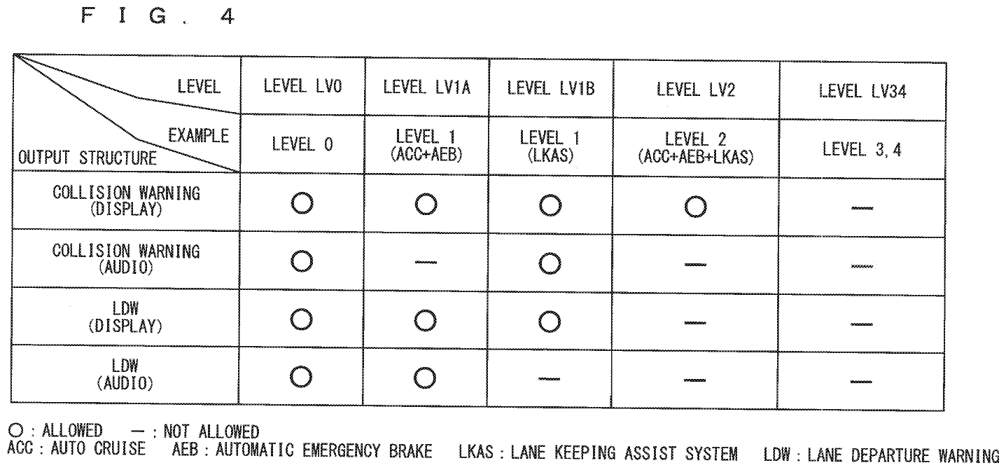

Hereinafter, about the automatic driving levels, the example shown in FIG. 2 will be referred to as a basic classification. Further, in the description later, more specific classification (see FIG. 4) will be used.

In the exemplary case shown in FIG. 2, in Levels 0 to 2, a driver has the driving authority, and in Levels 3 to 4, a vehicle has the driving authority. In Levels 1 to 2, though the vehicle performs part of driving tasks, when the driver performs a predetermined operation, the driver can instantly perform the driving tasks in preference to the vehicle. In Levels 3 to 4, the driver cannot basically perform the driving tasks and when the driver performs the driving tasks or changes the level to Level 2 or lower, a vehicle-side permission is needed.

As described above, when the driver has the driving authority, the automatic driving control device 100 controls the travel drive system 10 in accordance with the operation contents acquired from the drive operation device 20. In contrast to this, when the vehicle has the driving authority, the automatic driving control device 100 autonomously controls the travel drive system 10. For this reason, when the vehicle has the driving authority, even if the driver intends to operate the travel drive system 10 by using the drive operation device 20, if the automatic driving control device 100 determines that this operation content is not valid in the present situation, this operation content is not reflected. Further, in Level 3 of FIG. 2, when the operation content of the driver meets the request from the automatic driving control device 100, the operation content is determined to be valid and performed.

The automatic driving control device 100 has a map database 101. Hereinafter, “database” will be sometimes represented as “DB”. The map DB 101 is designed for automatic driving, has high-precision map data, and further has useful data for automatic driving, for example, road data. The road data is data on articulation and the like of carriageway marking lines drawn on a road surface. Further, the map DB 101 may be provided on the internet, and in this case, the automatic driving control device 100 makes access to the map DB 101 via the internet.

The automatic driving control device 100 makes a relatively long-term travel control plan on a planned travel route of the own vehicle by referring to the map DB 101. The planned travel route can be set as a road network within a predetermined range from an own vehicle position (i.e., a current position of the own vehicle) detected by the own vehicle position detection device 30. Alternatively, a guide route set by a navigation system may be set as the planned travel route.

Herein, the own vehicle position detection device 30 is formed of a GPS (Global Positioning System) receiver or the like, and detects the own vehicle position and supplies the detection result to the automatic driving control device 100. The own vehicle position detection device 30 may be configured so as to obtain the own vehicle position from information of an acceleration sensor, a gyroscope (gyro sensor), a vehicle speed signal, and the like, instead of or additional to the GPS reception information.

The automatic driving control device 100 sets a plurality of sections on the planned travel route in accordance with a predetermined section setting rule. Each section is defined as a spatial section or a time section. Alternatively, each section may be defined by both the spatial section and the time section. The spatial section can be defined by a planned starting point and a planned ending point, and each point can be defined by, for example, the longitude, latitude, and altitude. The time section can be defined by a planned starting time and a planned ending time.

The section setting rule includes a rule of dividing a section by the assumed automatic driving level on the basis of the map DB 101. Hereinafter, it is assumed that a section divided by the automatic driving level is referred to as a basic section.

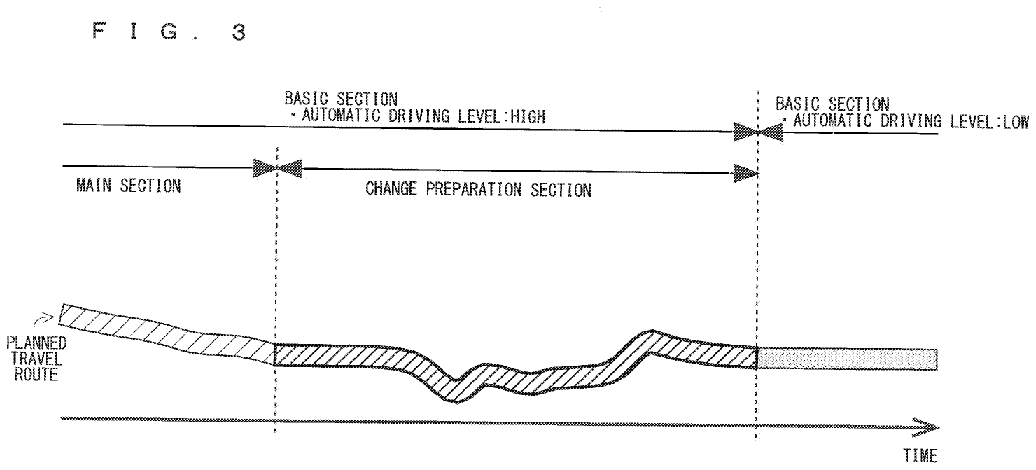

Further, the section setting rule includes another rule in which when the automatic driving level decreases in the two basic sections which are continuous in a traveling direction, a change preparation section should be provided at the end of the basic section with the higher automatic driving level. As shown in FIG. 3, the change preparation section is set so as to start during the basic section with the higher automatic driving level and ends at the start of the basic section with the lower automatic driving level. In the basic section with the higher automatic driving level, a section other than the change preparation section is referred to as a main section.

Herein, the change preparation section is assumed to be a section having a predetermined time width, e.g., a section of 10 minutes long. Specifically, the change preparation section is assumed to start the predetermined time width back from the planned starting time of the basic section with the lower automatic driving level. In other words, the change preparation section is assumed to start at a location a distance assumed to be traveled in the predetermined time width back from the planned starting point of the basic section with the lower automatic driving level.

A long-term travel control plan includes, for example, information on the type of each section, the start and end of the section, and the assumed automatic driving level of the section. Since each section is defined as a spatial section or a time section as described above, section start information which is information on the start of a section includes at least one of spatial information and time information. The same applies to section end information which is information on the end of a section.

Further, the automatic driving control device 100 makes a relatively short-term travel control plan on the basis of a surrounding condition of the own vehicle. The surrounding condition is detected by the surrounding condition detection device 40.

The surrounding condition detection device 40 detects a surrounding condition of the own vehicle and supplies the detection result to the automatic driving control device 100. The surrounding condition detection device 40 has sensing devices such as a millimeter-wave radar, an ultrasonic sensor, a laser radar, a camera, and the like, and acquires information to be used for automatic driving by using these sensing devices. For example, information on positions of lanes, other vehicles, pedestrians, buildings, obstacles, and the like are acquired. Further, for moving objects, a movement speed of each object is detected. The surrounding condition detection device 40 may acquire a surrounding condition of the own vehicle by using an in-vehicle communication device. Specifically, information on the degree of congestion, a road condition, and the like can be acquired through inter-vehicle communication which is communication between the own vehicle and the other vehicle, road-to-vehicle communication which is communication between the own vehicle and a roadside device, broadcast reception, or the like.

The information on the surrounding condition detected by the surrounding condition detection device 40 is used by the automatic driving control device 100, for collision avoidance, lane keeping, and the like. In consideration of this point, the short-term travel control plan relates to the degree of detection range of the surrounding condition detection device 40. On the other hand, the long-term travel control plan covers a range beyond the detection range of the surrounding condition detection device 40 and relates to assumable future traveling on the basis of the map DB 101 and the like.

The information output system 300 is a device for outputting information to users. In the first preferred embodiment, as shown in FIG. 1, a warning device 310 is taken as an example of the information output system 300. The warning device 310 outputs active safety warning as the information for users. For simple description, herein, the active safety warning refers to collision warning and lane departure warning (LDW).

The warning device 310 includes a warning light 311 for collision warning and a warning light 312 for lane departure warning which are provided in a meter cluster in front of the driver's seat. Further, the warning device 310 includes an acoustic device 313. In this case, in accordance with a combination of output information, an output format, and output destination devices 311, 312, and 313 included in the warning device 310, defined are the following four types of output structures.
Collision warning by display: the output information is the collision warning, the output destination device is the warning light 311, and the output format is display (herein, lighting of the warning light 311).
Collision warning by audio: the output information is the collision warning, the output destination device is the acoustic device 313, and the output format is audio (herein, utterance of synthesized voice saying “Beware of collision”).
Lane departure warning by display: the output information is the lane departure warning, the output destination device is the warning light 312, and the output format is display (herein, lighting of the warning light 312).
Lane departure warning by audio: the output information is the lane departure warning, the output destination device is the acoustic device 313, and the output format is audio (herein, utterance of synthesized voice saying “Beware of lane departure”).

Further, as an output by audio, a buzzer sound or a chime sound may be used.

The warning device 310 acquires information on the surrounding condition of the own vehicle from the surrounding condition detection device 40 and determines whether the output of warning is needed or not, on the basis of the acquired information and a predetermined alarm rule. Specifically, when a distance from the other vehicle is shorter than a value determined by the alarm rule, the warning device 310 determines that the output of the collision warning is needed. Further, when a distance between the own vehicle and a carriageway marking line on the road is shorter than a value determined by the alarm rule, the warning device 310 determines that the output of the lane departure warning is needed.

Particularly, whether or not the warning device 310 should actually output the warning is controlled by the information output control device 200. Specifically, only some of the above-described four types of output structures, which are allowed by the information output control device 200, are actually outputted. For this reason, for example, even when the warning device 310 determines that the collision warning should be outputted, there is a case where the collision warning by one of or both of display and audio are not allowed by the information output control device 200. This output control will be sufficiently understood through the following description on the information output control device 200.

As shown in FIG. 1, the information output control device 200 includes a section management unit 211 and an output control unit 212.

The section management unit 211 acquires various information on each section in the planned travel route from the automatic driving control device 100. Each section is set by the automatic driving control device 100 as described above. Further, the section management unit 211 determines a current section which is a section in which the own vehicle is present, among the plurality of sections in the planned travel route. Since the automatic driving control device 100 acquires the information on the own vehicle position from the own vehicle position detection device 30, the automatic driving control device 100 knows the current section. For this reason, by acquiring the determination result on the current section from the automatic driving control device 100, the section management unit 211 determines the current section.

The output control unit 212 controls the warning device 310 to perform information output to the user in the current section in accordance with the output structure allowed on the current section, among the above-described four types of output structures. Specifically, the output control unit 212 acquires the determination result on the current section from the section management unit 211, and controls an output from the warning device 310 on the basis of the determination result and output structure information 213.

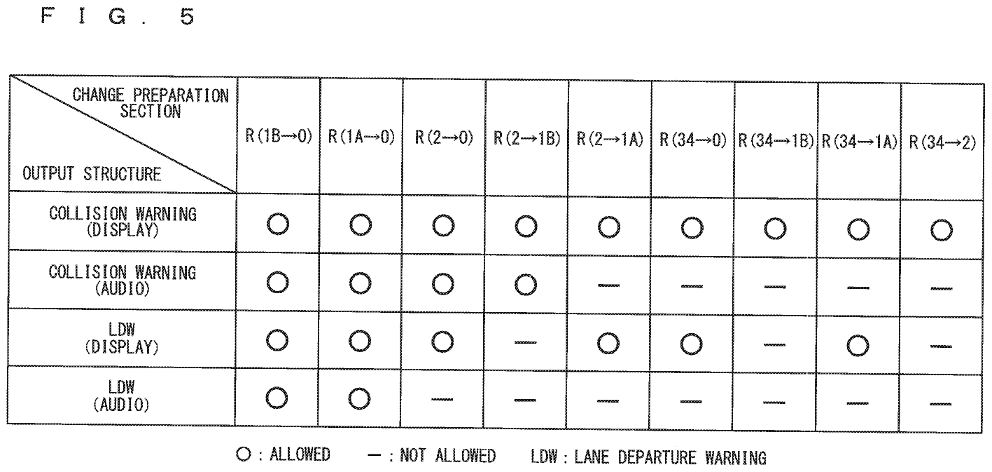

The output structure information 213 defines an output structure allowed to output (hereinafter, also referred to as an “allowed output structure”) and an output structure not allowed to output (hereinafter, also referred to as a “not-allowed output structure”) on the above-described four types of output structures. Exemplary contents of the output structure information 213 are shown in FIGS. 4 and 5.

In FIG. 4, the automatic driving levels are classified into five levels, i.e., LV0, LV1A, LV1B, VL2, and LV34. The level, LV0 corresponds to Level 0 in the classification of FIG. 2. The level LV1A corresponds to Level 1 in the classification of FIG. 2, and herein corresponds to a state in which the automatic driving control device 100 performs the auto cruise (ACC) and the automatic emergency brake (AEB). The level LV1B corresponds to Level 1 in the classification of FIG. 2, and herein corresponds to a state in which the automatic driving control device 100 performs the lane keeping assist system (LKAS). The level LV2 corresponds to Level 2 in the classification of FIG. 2, and herein corresponds to a state in which the automatic driving control device 100 performs the auto cruise (ACC), the automatic emergency brake (AEB), and the lane keeping assist system (LKAS). The level LV34 corresponds to Level 3 and Level 4 in the classification of FIG. 2.

Further, it is assumed hereinafter that the automatic driving control device 100 divides the basic section in accordance with the five automatic driving levels shown in FIG. 4.

FIG. 4 defines the allowed output structure and the not-allowed output structure in the basic section, which are set by the automatic driving level. Specifically, in the section with the automatic driving level of LV0, all the output structures, i.e., the collision warning by display, the collision warning by audio, the lane departure warning by display, and the lane departure warning by audio, are allowed. On the other hand, in the section of LV34, no output structure is allowed. Further, in the respective sections of LV1A, LV1B, and LV2, only some of the four types of output structures are allowed.

The rule shown in FIG. 4 is based on the notion that the necessity to output the warning is lower as the automatic driving level is higher. In LV34, particularly, since the vehicle has the driving authority, it is thought that it is not necessary to output the warning to the driver. For this reason, the rule of FIG. 4 defines that neither the collision warning nor the lane departure warning is outputted in the section of LV34.

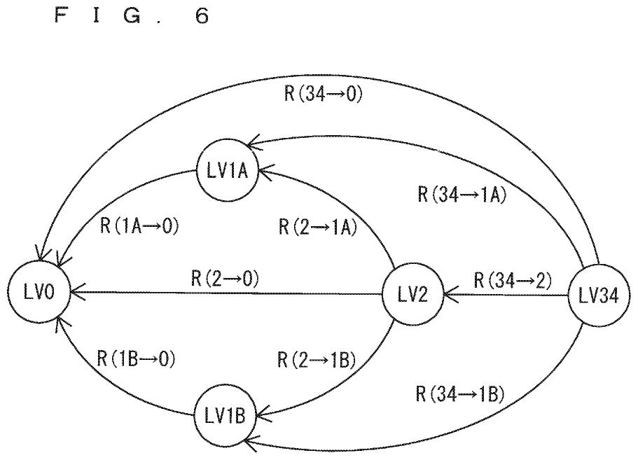

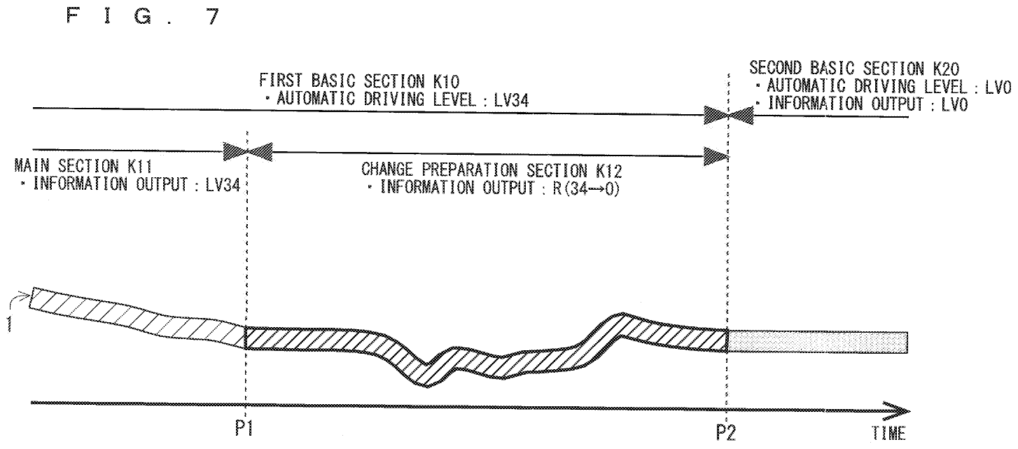

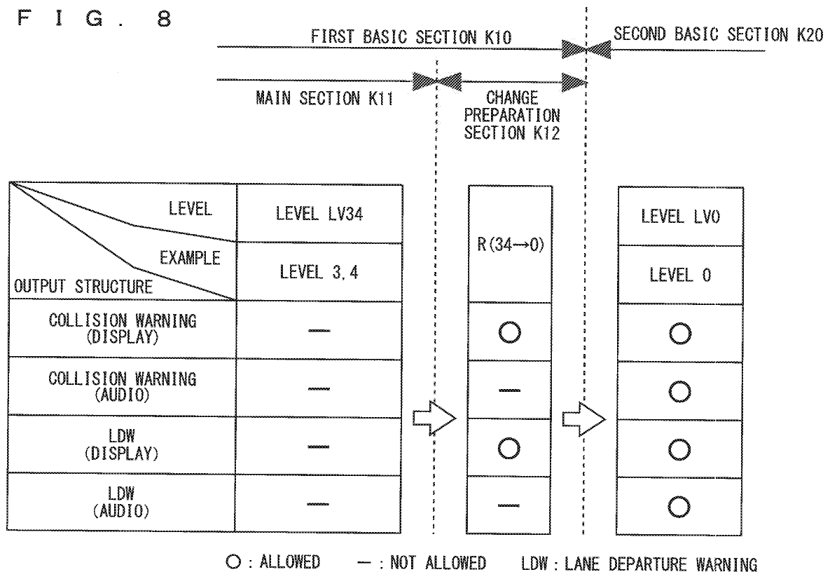

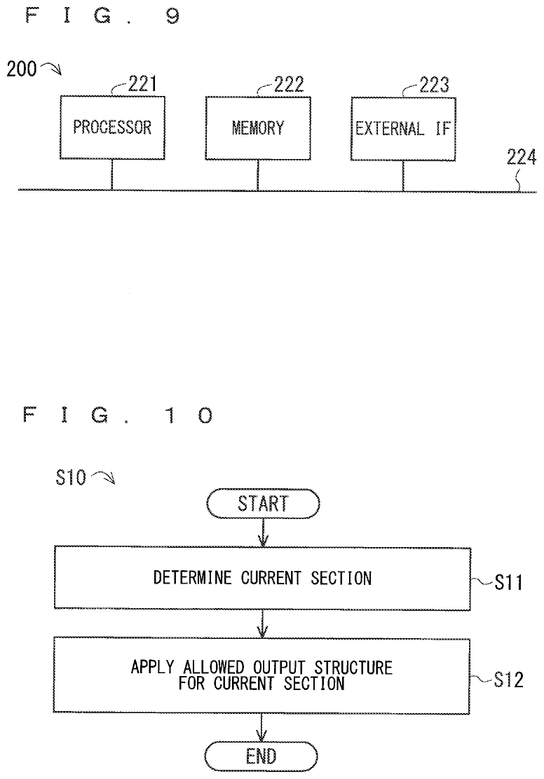

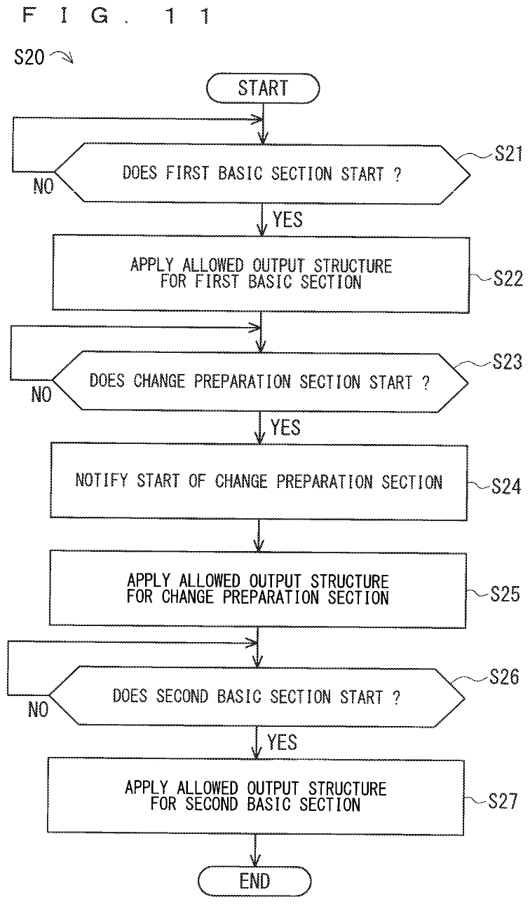

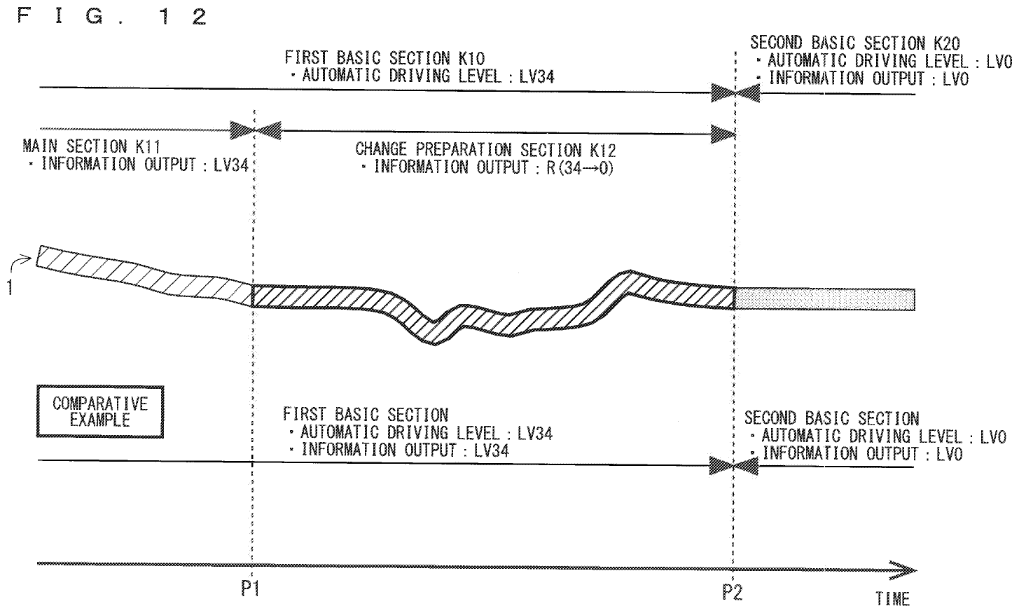

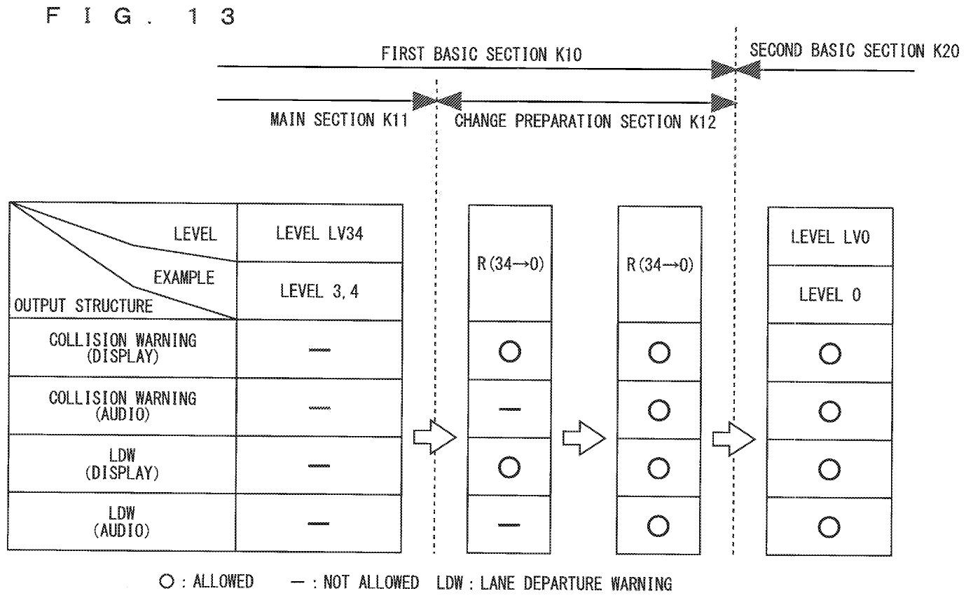

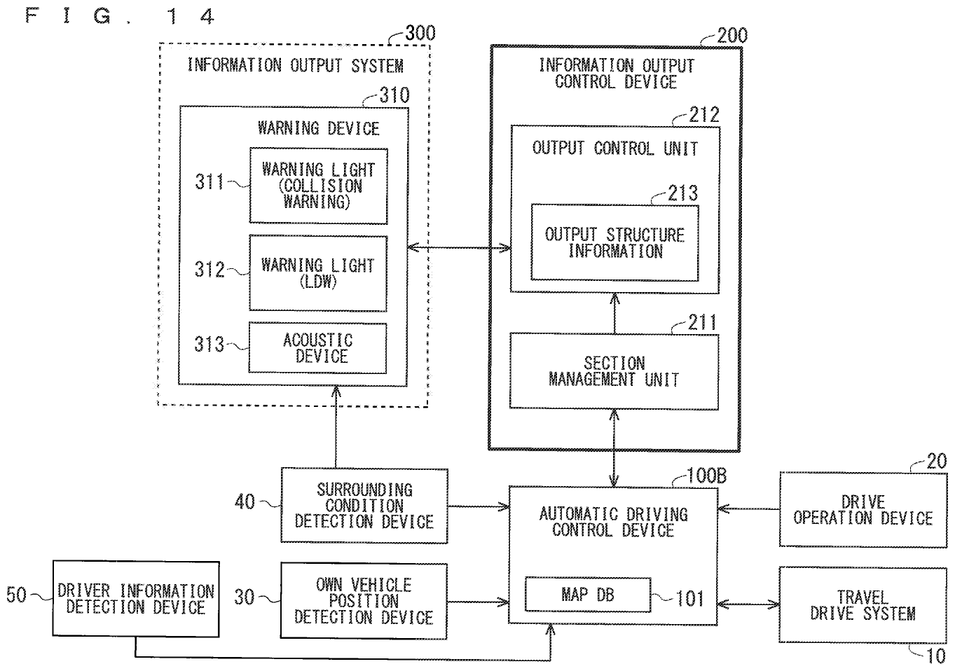

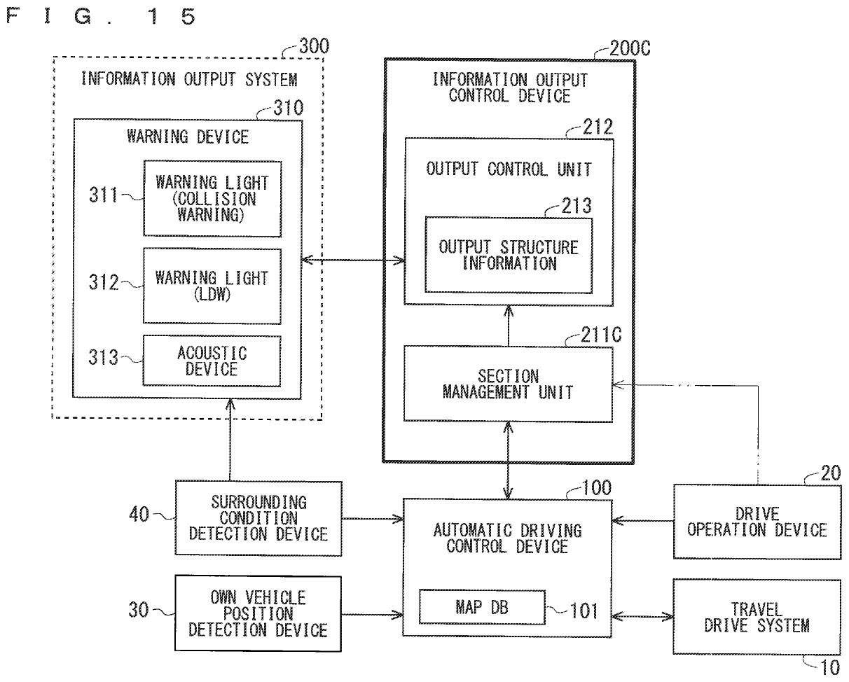

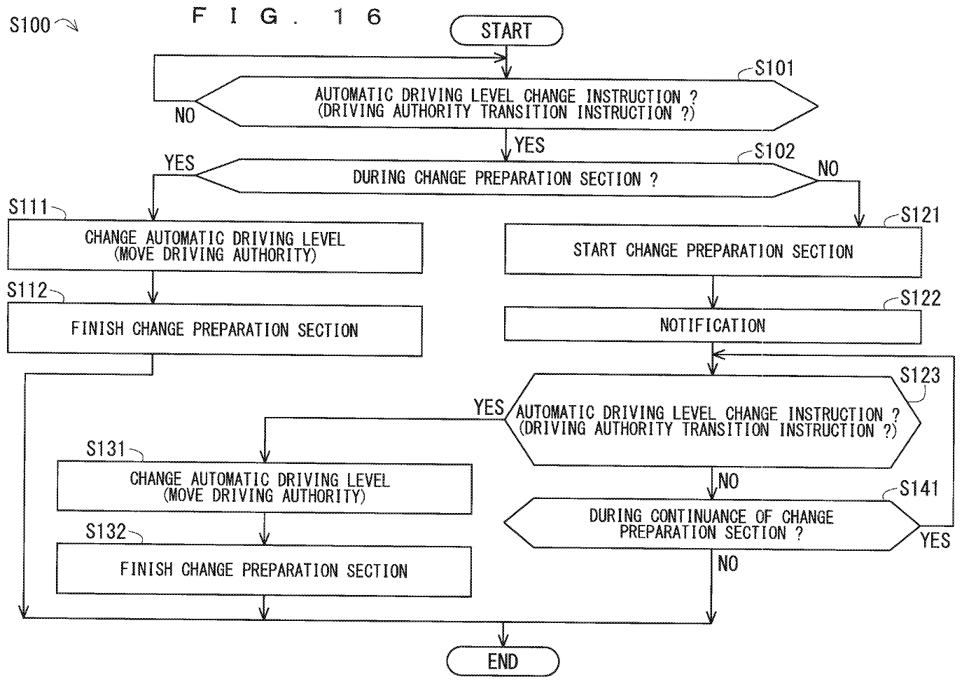

FIG. 5 defines the allowed output structure and the not-allowed output structure in the change preparation section. In FIG. 5, for example, R(1B→0) refers to a change preparation section in the case where the automatic driving level decreases from the level LV1B to the level LV0. Under the five automatic driving levels LV0, LV1A, LV1B, VL2, and LV34, as shown in the transition diagram of FIG. 6, nine change preparation sections are defined. FIG. 5 defines whether “allowed” or “not allowed” of each output structure on each of the nine change preparation sections.

Herein, it is assumed that when a change preparation section is set, for a main section, the output structures for the basic section (see FIG. 4) including the main section are applied. In other words, the output structures for the change preparation section (see FIG. 5) are defined separately from the output structures for the basic section (see FIG. 4), and for this reason, for the change preparation section, the output structures for the change preparation section are applied preferentially.

According to FIGS. 4 and 5, the allowed output structures for the change preparation section are defined so as to include part of the not-allowed output structures for the main section before the change preparation section. Moreover, the allowed output structures for the change preparation section are defined so as to include at least part of the allowed output structures for the basic section following the change preparation section.

FIG. 7 shows a more specific example. FIG. 7 shows a plan view spatially indicating a planned travel route 1 and also shows a time base taking the planned travel route 1 in terms of time. According to FIG. 7, the planned travel route 1 includes a first basic section K10 and a second basic section K20 continuous from the first basic section K10. The first basic section K10 is a section in which the vehicle is planned to travel at a first automatic driving level (herein, LV34). The second basic section K20 is a section in which the vehicle is planned to travel at a second automatic driving level (herein, LV0) lower than the first automatic driving level.

When the vehicle travels the planned travel route 1 from the first basic section K10 toward the second basic section K20, the automatic driving level decreases. For this reason, at the end period of the first basic section K10, a change preparation section K12 is provided. In FIG. 7, since the first automatic driving level is LV34 and the second automatic driving level is LV0, the change preparation section K12 is a change preparation section R(34→0).

In FIG. 7, a time P1 is a planned starting time of the change preparation section K12, in other words, a planned ending time of the main section K11 in the first basic section K10. Further, a time P2 is a planned ending time of the change preparation section K12, in other words, a planned starting time of the second basic section K20.

When the section management unit 211 determines that the current section is the main section K11 in the first basic section K10, the output control unit 212 controls the warning device 310 in accordance with the allowed output structures for the section with the automatic driving level of LV34. According to FIG. 4, in the section of LV34, none of the four types of output structures are allowed. For this reason, even when the warning device 310 determines that the collision warning should be outputted, the output control unit 212 controls the warning device 310 to output neither the collision warning by display nor the collision warning by audio. The same applies to the lane departure warning.

When the section management unit 211 determines that the current section is the change preparation section K12 in the first basic section K10, the output control unit 212 controls the warning device 310 in accordance with the allowed output structures for the change preparation section R(34→0). According to FIG. 5, in the change preparation section R(34→0), the collision warning by display and the lane departure warning by display are allowed and the collision warning by audio and the lane departure warning by audio are not allowed. For this reason, when the warning device 310 determines that the collision warning should be outputted, the output control unit 212 controls the warning device 310 to output the collision warning by display and not to output the collision warning by audio. The same applies to the lane departure warning.

When the section management unit 211 determines that the current section is the second basic section K20, the output control unit 212 controls the warning device 310 in accordance with the allowed output structures for the section with the automatic driving level of LV0. According to FIG. 4, in the section of LV0, all the output structures are allowed. For this reason, when the warning device 310 determines that the collision warning should be outputted, the output control unit 212 controls the warning device 310 to output both the collision warning by display and the collision warning by audio. The same applies to the lane departure warning.

FIG. 8 shows a table in which the contents of FIGS. 4 and 5 are included in FIG. 7. According to FIG. 8, it can be seen that the allowed output structures for the change preparation section K12 include part of the not-allowed output structures for the main section K11 and also include part of the allowed output structures for the second basic section K20. Herein, the allowed output structures for the change preparation section K12 may include all the allowed output structures for the second basic section K20. For example, see the change preparation section R(1B→0) shown in FIG. 5. Specifically, the allowed output structures for the change preparation section K12 include at least part of the allowed output structures for the second basic section K20.

FIG. 9 shows a hardware constitution diagram of the information output control device 200. As shown in FIG. 9, the information output control device 200 includes a processor 221, a memory 222, and an external interface 223. Hereinafter, “interface” will be sometimes represented as “IF”. According to FIG. 9, the processor 221, the memory 222, and the external IF 223 are connected to one another through a bus 224. Connection of these constituent elements, however, is not limited to this connection manner.

The memory 222 is formed of one or a plurality of memory devices. The memory device is, for example, a semiconductor memory (ROM (Read Only Memory), RAM (Random Access Memory), a rewritable nonvolatile memory, or/and the like), or a HD (hard disk) device. The memory 222 may include both the semiconductor memory and the HD device.

The external IF 223 is an IF circuit for connecting the information output control device 200 and an external device, and herein a communication circuit for the automatic driving control device 100. When the specifications define that the information output control device 200 and the automatic driving control device 100 can be connected to each other not through the external IF 223, however, the automatic driving control device 100 is connected to, for example, the bus 224. It is assumed that the warning device 310 can be connected to the information output control device 200 not through the external IF, but the external IF is sometimes needed depending on the specifications. In other words, the external IF is provided as necessary, and for this reason, sometimes the information output control device 200 does not include the external IF.

The processor 221 executes a program stored in the memory 222, to thereby implement various functions of the information output control device 200. Specifically, the processor 221 executes a program for the section management unit 211, to thereby implement the section management unit 211. Similarly, the processor 221 executes a program for the output control unit 212, to thereby implement the output control unit 212. The output structure information 213 is assumed to be stored in the memory 222 as a database. Alternatively, the output structure information 213 may be described in the program for the output control unit 212.

In the above description, the processor 221 executes the program, to thereby implement the information output control device 200 by software. In contrast to this, part or all of the functions of the information output control device 200 may be implemented by dedicated hardware.

FIG. 10 is a flowchart showing an operation of the information output control device 200. FIG. 10 shows a basic operation flow S10. According to the operation flow S10, in Step S11, the section management unit 211 acquires the determination result on the current section from the automatic driving control device 100, to thereby determine the current section. Then, in Step S12, the output control unit 212 applies the allowed output structures for the current section. Specifically, the output control unit 212 controls the warning device 310 to perform the information output to the user in accordance with the allowed output structures for the current section. By repeating the operation flow S10, the warning device 310 is controlled as necessary in accordance with the change of the current section.

FIG. 11 shows a more specific flowchart. An operation flow S20 shown in FIG. 11 particularly relates to FIG. 7 showing the situation in which the automatic driving level decreases. According to the operation flow S20, in Step S21, the section management unit 211 determines whether the first basic section K10 starts or not. When the first basic section K10 does not start, Step S21 is repeated. When the section management unit 211 determines that the first basic section K10 starts, the output control unit 212 applies the allowed output structures for the first basic section K10 in Step S22.

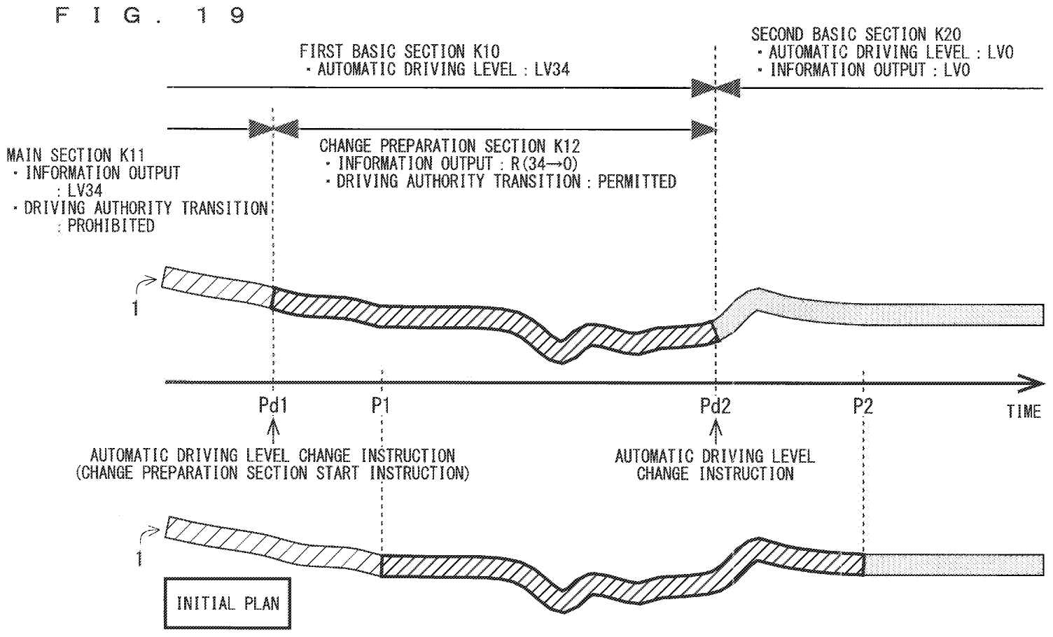

After Step S21, the section management unit 211 determines whether the change preparation section K12 starts or not in Step S23. When the change preparation section K12 does not start, Step S23 is repeated. When the section management unit 211 determines that the change preparation section K12 starts, the output control unit 212 notifies the start of the change preparation section K12 by using the warning device 310 or other devices (for example, an HMI (Human Machine Interface) device 320 shown in FIG. 20, described later) in Step S25. This notification is performed by either or both of display and audio. Further, Step S24 may be omitted. Then, the output control unit 212 applies the allowed output structures for the change preparation section K12 in Step S25.

After Step S23, the section management unit 211 determines whether the second basic section K20 starts or not in Step S26. When the second basic section K20 does not start, Step S26 is repeated. When the section management unit 211 determines that the second basic section K20 starts, the output control unit 212 applies the allowed output structures for the second basic section K20 in Step S27.

Further, each of Steps S21, S23, and S26 corresponds to Step S11 in the operation flow S10, and each of Steps S22, S25, and S27 corresponds to Step S12 in the operation flow S10.

FIG. 12 is a view in which a comparative example is added to FIG. 7. In the comparative example, the change preparation section K12 is not set. For this reason, through the entire first basic section K10, the allowed output structures for the first basic section K10 (herein, for the first automatic driving level LV34) are applied.

In contrast to this, according to the information output control device 200, in the change preparation section K12 before the second basic section K20, part or all of the allowed output structures for the second basic section K20 (herein, for the second automatic driving level LV0) are applied. For this reason, the driver can bodily sense the information output after the automatic driving level decreases, before the automatic driving level decreases. Therefore, the driver can become accustomed to the car environment after the automatic driving level decreases, and can smoothly adapt to a decrease in the automatic driving level.

In the above description, as the output information, taken are the collision warning and the lane departure warning which are the active safety warnings. The output information may be other active safety warnings, for example, the presence of an obstacle, the approach of an moving object (person, animal, or the like), the traveling environment (road condition, crosswind, or the like), or the like.

Further, in the above description, as the output format, taken are the display by the warning light and the audio output. The output format may be, for example, display of characters or an image, or vibration.

Furthermore, as the output format, a visual guidance display may be used. Specifically, in an image of a landscape in the traveling direction captured by a vehicle-mounted camera, a visual guidance object is displayed on a portion (e.g., an image of an object) to which attention should be drawn. Alternatively, there may be a case where by using a head up display (HUD) to display the visual guidance object thereon, the visual guidance object appears in a landscape which can be seen through a windshield of the vehicle. The visual guidance object can be formed of, for example, a figure or a message.

Further, as the output format, a sound image position may be used. Specifically, by using acoustic devices which can set the sound image positions at a plurality of positions in the vehicle, a plurality of sound image positions are used as different output formats. The sound image position is referred to also as a sound image localization position.

In the above description, the warning device 310 determines whether to output each of all types of warnings. In contrast to this, the information output control device 200 may control the warning to be determined. As shown in FIG. 4, for example, in the case of the automatic driving level LV2, the lane departure warning is not outputted. In consideration of this point, in the case of the automatic driving level LV2, the output control unit 212 of the information output control device 200 may instruct the warning device 310 not to determine whether the lane departure warning is needed or not.

In the above description, the change preparation section is set by the automatic driving control device 100. In contrast to this, the section management unit 211 of the information output control device 200 may set the change preparation section. Specifically, the section management unit 211 acquires the long-term travel control plan (however, not including the information on the change preparation section) from the automatic driving control device 100 and sets the change preparation section on the basis of the travel control plan.

In the above description, the section management unit 211 acquires the determination result on the current section from the automatic driving control device 100. In contrast to this, the section management unit 211 may acquire the long-term travel control plan and the own vehicle position from the automatic driving control device 100, to thereby determine the current section by itself.

By these variations, the above-described effects can be produced.

### The Second Preferred Embodiment

In the information output control device 200, as the change preparation section K12 approaches an end, the number of allowed output structures for the change preparation section K12 may increases. As shown in FIG. 13, for example, in a case where the change preparation section R(34→0) is 10 minutes long, the collision warning by display and the lane departure warning by display are allowed for 6 minutes from the start thereof, and the collision warning by audio and the lane departure warning by audio are further allowed for remaining 4 minutes. The information on the target change preparation section, the increase pattern of the allowed output structures, and the time allocation relating to the increase is not limited to the exemplary case shown in FIG. 13. Further, the information is assumed to be included in the output structure information 213. According to the second preferred embodiment, the same effects as those in the first preferred embodiment can be produced.

### The Third Preferred Embodiment

In the first and second preferred embodiments, the change preparation section K12 is fixedly set to be 10 minutes long. In contrast to this, the change preparation section K12 may be set variably.

For example, as the planned travel route is more crowded, the change preparation section K12 is set longer. As described in the first preferred embodiment, the surrounding condition detection device 40 can acquire the degree of congestion of the planned travel route through inter-vehicle communication which is communication between the own vehicle and the other vehicle, road-to-vehicle communication which is communication between the own vehicle and a roadside device, broadcast reception, or the like. The automatic driving control device 100 applies the degree of congestion detected by the surrounding condition detection device 40 to information defining in advance a relation between the degree of congestion and the length of the change preparation section K12, to thereby set the length of the change preparation section K12.

Alternatively, there may be a case where as an attention level of the driver is lower, the change preparation section K12 is set longer. The attention level of the driver is determined, for example, from the viewpoint of whether the driver has sleepiness or not, whether the driver performs inattentive driving or not, and whether the driver is calm or not (in other words, not excited).

As shown in FIG. 14, the attention level of the driver can be detected by a driver information detection device 50. The driver information detection device 50 has, for example, an in-vehicle camera which captures an image of the driver, as a sensor, and then movements of eyeballs and face of the driver are detected by analyzing the image captured by the camera and the attention level of the driver is determined from the direction of the line of sight and the orientation of the face of the driver. The sensor of the driver information detection device 50 has only to detect the behavior of the driver. For this reason, other sensors may be used. As other sensors, for example, a sound collecting microphone for acquiring the voice of the driver, a biosensor provided on the steering wheel, or a brain wave sensor may be used.

An automatic driving control device 100B shown in FIG. 14 applies the attention level of the driver detected by the driver information detection device 50 to information defining in advance a relation between the attention level and the length of the change preparation section K12, to thereby set the length of the change preparation section K12. Further, other operations of the automatic driving control device 100B are the same as those of the already-described automatic driving control device 100.

Alternatively, in accordance with the respective values of the first automatic driving level and the second automatic driving level, the length of the change preparation section K12 may be set. It is set, for example, that R(4→3) is 5 minutes long, R(3→0) is 10 minutes long, and R(3→2) is 8 minutes long. In this case, the automatic driving control device 100 applies the respective values of the target first and second automatic driving levels to the information defining in advance a relation between respective values of the first automatic driving level and the second automatic driving level and the length of the change preparation section K12, to thereby set the length of the change preparation section K12.

As described in the first preferred embodiment, the change preparation section is set in accordance with the section setting rule. In consideration of the first and third preferred embodiments, the section setting rule can include at least one of the following rules.

a rule defining that the change preparation section is set to have a fixed length determined in advance,

a rule defining that the change preparation section is set longer as the planned travel route is more crowded,

a rule defining that the change preparation section is set longer as the attention level of the driver is lower, and

a rule defining that the length of the change preparation section is set in accordance with respective values of the first automatic driving level and the second automatic driving level.

Further, there may be a case where the exercise load of the driver in the case where the automatic driving level is changed to a lower level is predicted and as the exercise load is larger, the change preparation section is set longer. Other than the above, when there is a curve, a branch, merging, or the like, the exercise load is expected to be larger.

Furthermore, as described in the first preferred embodiment, the automatic driving control device 100 may set the change preparation section or the section management unit 211 of the information output control device 200 may set the change preparation section.

According to the third preferred embodiment, the same effects as those in the first preferred embodiment can be produced.

### The Fourth Preferred Embodiment

In the fourth preferred embodiment, a case will be described, where the automatic driving level is changed by an instruction of the driver. FIG. 15 is a block diagram showing an information output control device 200C in accordance with the fourth preferred embodiment and an application example of the information output control device 200C. As shown in FIG. 15, the constitution of the information output control device 200C is basically the same as that of the already-described information output control device 200, but a section management unit 211C of the information output control device 200C further perform an operation described later.

Further, it is assumed that the first automatic driving level is a state in which the vehicle has the driving authority and the second automatic driving level is a state in which the driver has the driving authority. As an example thereof, with reference to FIG. 7, a case will be described, where the first automatic driving level is LV34 and the second automatic driving level is LV0. Particularly, in the state in which the vehicle has the driving authority, and specifically in the first basic section K10 where the automatic driving level is LV34, it is basically prohibited that the driving authority is moved from the vehicle to the driver. Specifically, it is assumed that while such driving authority transition is prohibited in the main section K11, it is permitted in the change preparation section K12.

FIG. 16 is a flowchart showing an operation of the information output control device 200C in accordance with the fourth preferred embodiment. An operation flow S100 shown in FIG. 16 is performed concurrently with the operation flow S10 of FIG. 10 and the operation flow S20 of FIG. 11.

According to the operation flow S100, in the Step S101, the section management unit 211C determines whether an automatic driving level change instruction instructing to change the automatic driving level is inputted or not. Herein, it is assumed that the instruction to be determined is an instruction to change from the level in which the vehicle has the driving authority to the level in which the driver has the driving authority, for example, as shown in FIG. 7, an instruction to change from the level LV34 to the level LV0. In this case, the automatic driving level change instruction may be referred to also as a driving authority transition instruction.

The automatic driving level change instruction is inputted when the driver operates the drive operation device 20 (for example, the handle lever). In this case, the automatic driving level change instruction is supplied from the drive operation device 20 through the automatic driving control device 100 to the section management unit 211C. Alternatively, as indicated by the two-dot chain line in FIG. 15, there may be a configuration where the automatic driving level change instruction is supplied directly from the drive operation device 20 to the section management unit 211C.

Still alternatively, there may be another configuration where the automatic driving level change instruction is inputted by another device (for example, the HMI apparatus 320 of FIG. 20, described later) and supplied from the device directly or indirectly to the section management unit 211C.

When the automatic driving level change instruction is not inputted, the above-described Step S101 is repeated. In contrast to this, when the section management unit 211C acquires the automatic driving level change instruction, the section management unit 211C determines, in Step S102, whether the current section is the change preparation section K12 or not.

When the current section is the change preparation section K12, the section management unit 211C causes the automatic driving control device 100 to execute the automatic driving level change instruction in Step S111. The automatic driving level is thereby changed from the level LV34 to the level LV0. Further, as described above, it is allowed that the driving authority is moved from the vehicle to the driver during the change preparation section K12.

Then, in Step S112, the section management unit 211C finishes the change preparation section K12 concurrently with the start of the automatic driving level LV0. The operation flow S100 is thereby finished. In this case, as shown in FIG. 17, the change preparation section K12 is ended ahead of the initial plan. Further, after the change preparation section K12 is finished and the second basic section K20 starts, the allowed output structures for the second basic section K20 are applied. See Steps S26 to S27 in the operation flow S20 of FIG. 11.

When the section management unit 211C determines, in the above-described Step S102, that the current section is not the change preparation section K12, the automatic driving level change instruction cannot be executed at this point. This is because it is prohibited, as described above, that the driving authority is moved from the vehicle to the driver during the main section K11.

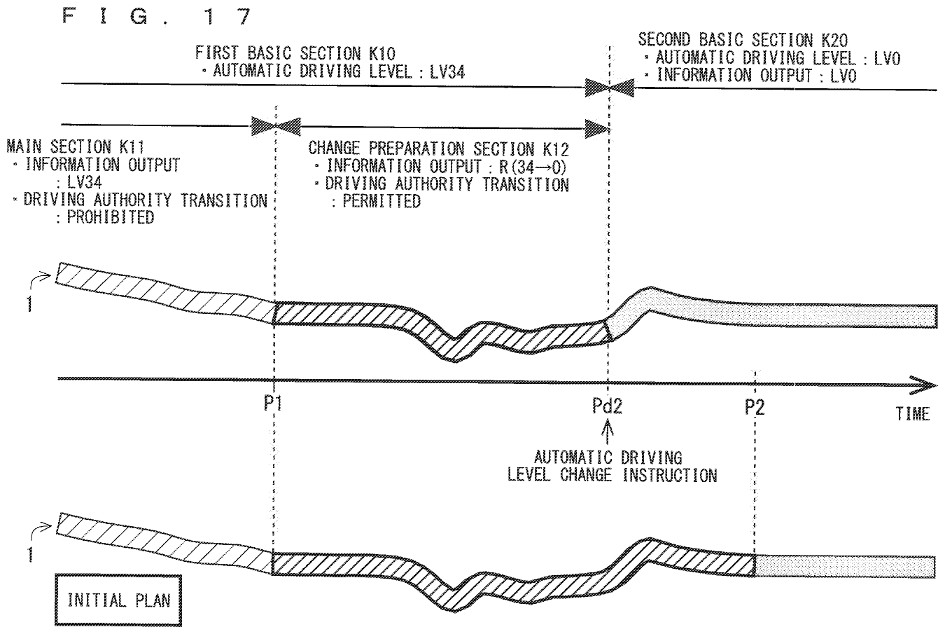

According to the operation flow S100, when the section management unit 211C determines, in Step S102, that the current section is not the change preparation section K12, the section management unit 211C starts the change preparation section K12 ahead of the plan in Step S121. (see FIG. 18). Further, after the change preparation section K12 starts, the allowed output structures for the change preparation section K12 are applied. See Steps S23 and S25 in the operation flow S20 of FIG. 11.

Specifically, in Step S121, the automatic driving level change instruction inputted during the main section K11 is used as an instruction to form a state in which the automatic driving level change instruction can be received, specifically, a change preparation section start instruction to start the change preparation section K12.

After that, in Step S122, after the section management unit 211C informs the output control unit 212 of the start of the change preparation section K12, the output control unit 212 notifies the start of the change preparation section K12 by using the warning device 310 or other devices (for example, the HMI apparatus 320 of FIG. 20, described later). This Step S122 corresponds to Step S24 in the operation flow S20 of FIG. 11. This notification is performed by either or both of display and audio.

In Step S122, it may be notified that the change preparation section K12 has started, or it may be notified that the state in which transition of the driving authority is allowed has started. Each of these notifications prompts a reinput of the automatic driving level change instruction. Naturally, the prompt itself to reinput the automatic driving level change instruction may be notified.

Further, it is assumed that the transition of the driving authority is allowed immediately after the start of the change preparation section K12. Alternatively, the transition of the driving authority may be allowed after a predetermined time has elapsed after the start of the change preparation section K12 or when a predetermined condition is satisfied.

By the notification in Step S122, the driver can know that the last automatic driving level change instruction is not reflected on the actual change of the automatic driving level, in other words, the actual transition of the driving authority. Further, the driver can know that reinput of the automatic driving level change instruction is required. For this reason, high convenience can be provided.

After that, in Step S123, the section management unit 211C determines whether the automatic driving level change instruction is inputted again or not. Further, Step S123 can be performed in the same manner as the above-described Step S101.

When the section management unit 211C acquires the automatic driving level change instruction, the section management unit 211C causes the automatic driving control device 100 to execute the automatic driving level change instruction in Step S131. The automatic driving level is thereby changed from the level LV34 to the level LV0. Further, Step S131 can be performed in the same manner as the above-described Step S111.

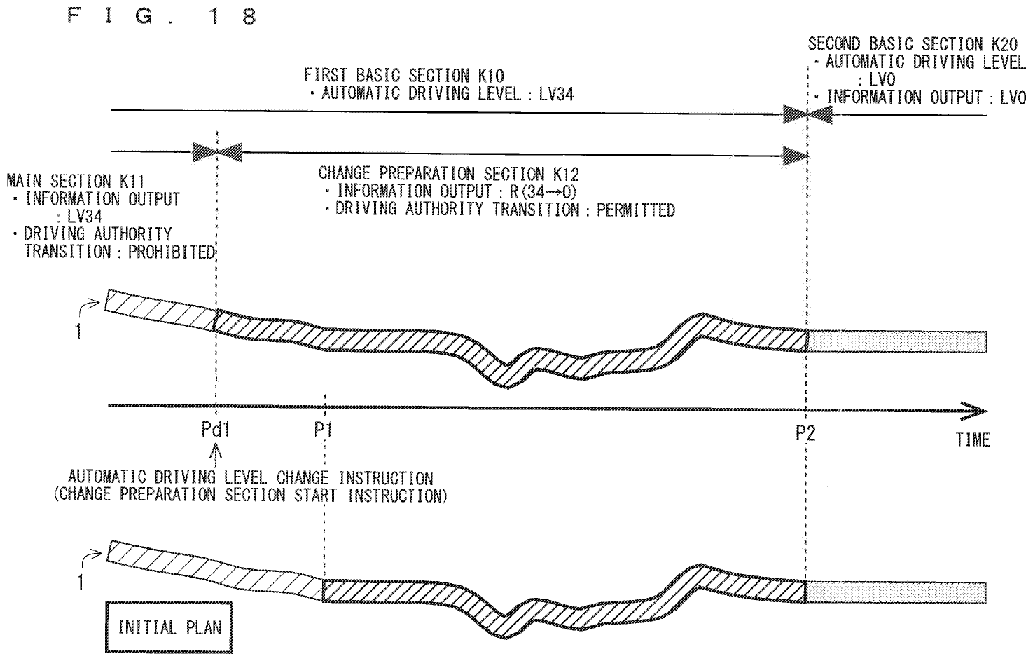

Then, in Step S132, the section management unit 211C finishes the change preparation section K12 concurrently with the start of the automatic driving level LV0. The operation flow S100 is thereby finished. In this case, as shown in FIG. 19, the change preparation section K12 is ended ahead of the initial plan. Further, Step S132 can be performed in the same manner as the above-described Step S112.

On the other hand, when the section management unit 211C cannot acquire the automatic driving level change instruction in the above-described Step S123, the section management unit 211C determines, in Step S141, whether the change preparation section K12 continues or not. When the change preparation section K12 continues, the operation of the section management unit 211C goes back to the above-described Step S123. On the other hand, when the change preparation section K12 does not continue, in other words, when the change preparation section K12 is ended while no automatic driving level change instruction is reinputted, the operation flow S100 is finished.

Herein, the operation flow S100 includes the process for finishing the change preparation section K12 ahead of plan and the process for starting the change preparation section K12 ahead of plan. In contrast to this, an operation flow may be configured so as to perform either one of the processes. For example, the process for finishing the change preparation section K12 ahead of plan can be applied, regardless of which has the driving authority. Specifically, even when an instruction to decrease the automatic driving level is given during the change preparation section K12 in a section in which the driver has the driving authority, the process for finishing the change preparation section K12 ahead of plan can be applied.

According to the fourth preferred embodiment, the same effects as those in the first preferred embodiment can be produced. Particularly, the effects can be achieved in the configuration in which the automatic driving level can be changed by the instruction of the driver. Further, as described above, by the notification in Step S122, high convenience can be provided.

### The Fifth Preferred Embodiment

FIG. 20 is a block diagram showing an information output control device 200D in accordance with the fifth preferred embodiment and an application example of the information output control device 200D. In the fifth preferred embodiment, an information output system 300D and a content supply device 400 are provided. Further, instead of the warning device 310, a warning device 310D is provided.

The information output system 300D includes an HMI (Human Machine Interface) device 320. The HMI apparatus 320 is a device which outputs information to the driver or a passenger and receives an operation of the driver or the passenger. The HMI apparatus 320 includes a display 321, an acoustic device 322, and an operation device 323. The HMI apparatus 320 is connected to the information output control device 200D. Further, the HMI apparatus 320 is connected to the information output control device 200D through the external IF 223 for the HMI apparatus 320 as necessary.

The display 321 includes a liquid crystal display (LCD) arranged in the meter cluster in front of the driver's seat. Instead of, or additional to the liquid crystal display in the meter cluster, however, the display 321 may include one or more of a liquid crystal display arranged in a center console between the front of the driver's seat and the front of the passenger's seat, a liquid crystal display arranged in front of the passenger's seat, and a liquid crystal display arranged on a headrest of the front seat. Further, any type of display other than liquid crystal may be used. Furthermore, the display 321 may include a head up display (HUD) using a windshield. Hereinafter, the head up display is sometimes referred to as an HUD.

Herein, the display 321 is also used by the warning device 310D. In this case, the warning device 310D performs warning by display by displaying a warning object on the display 321. Specifically, the warning device 310D holds image data for various warning objects, and selects the warning object in accordance with the type of warning and displays the selected warning object on the display 321. The warning object is, for example, a warning light object, a visual guidance object, or a warning message.

Further, the warning device 310D uses the acoustic device 322. In this case, the warning device 310D holds audio data for various warnings, and selects the audio data in accordance with the type of warning and reproduces the selected audio data on the acoustic device 322. The audio data for warning is, for example, a synthesized voice saying warning contents, a buzzer sound, and a chime sound.

The operation device 323 is a device for operating the display 321 and the acoustic device 322. Further, the operation device 323 is used to operate the content supply device 400. The operation device 323 includes at least one of a touch panel, a switch, a button, and the like.

Herein together with the content supply device 400, the HMI apparatus 320 constitutes a so-call in-vehicle information system. The HMI apparatus 320 may be, however, a dedicated device for the information output control device 200D. Further, there may be a configuration where the HMI apparatus of the in-vehicle information system and the HMI apparatus dedicated to the information output control device 200D are provided and both the HMI apparatuses are connected to the information output control device 200D. Furthermore, the HMI apparatus 320 may include a vibration generator (for example, arranged on the steering wheel).

The content supply device 400 supplies content data of various output information to the HMI apparatus 320. The content data are reproduced by at least one of the display 321 and the acoustic device 322 of the HMI apparatus 320, and the contents thereof, i.e., the output information are thereby provided to the user. Further, as described above, the content supply device 400 is operated by the operation device 323 of the HMI apparatus 320.

It is assumed that the content supply device 400 includes a reproduction device for entertainment information and a navigation system. It is assumed that the entertainment information is an AV (audiovisual) content. In this case, the reproduction device of the entertainment information includes at least one of a reproduction device for an optical disk such as a DVD or the like, a memory device storing the content data therein, and a television receiver. The entertainment information may be, for example, music contents, and the reproduction device for the entertainment information may include a radio receiver.

As described above, the warning device 310D uses the display 321 and the acoustic device 322 of the HMI apparatus 320. In other words, the warning device 310D itself does not have any output function by display and audio. For this reason, the warning device 310D determines whether to output the warning and when the warning device 310D determines that the warning should be outputted, the warning device 310D supplies the display 321 and the acoustic device 322 with the content data for warning. In consideration of this point, as shown in FIG. 20, the warning device 310D is classified into the content supply device 400.

As shown in FIG. 20, the constitution of the information output control device 200D is basically the same as that of the already-described information output control device 200, but an output control unit 212D of the information output control device 200D controls the information output by the HMI apparatus 320 on the basis of output structure information 213D. Specifically, the output control unit 212D controls the display 321 and acoustic device 322 to selectively use the data in conformity with the allowed output structures for the current section among the content data which the display 321 and the acoustic device 322 acquire from the content supply device 400.

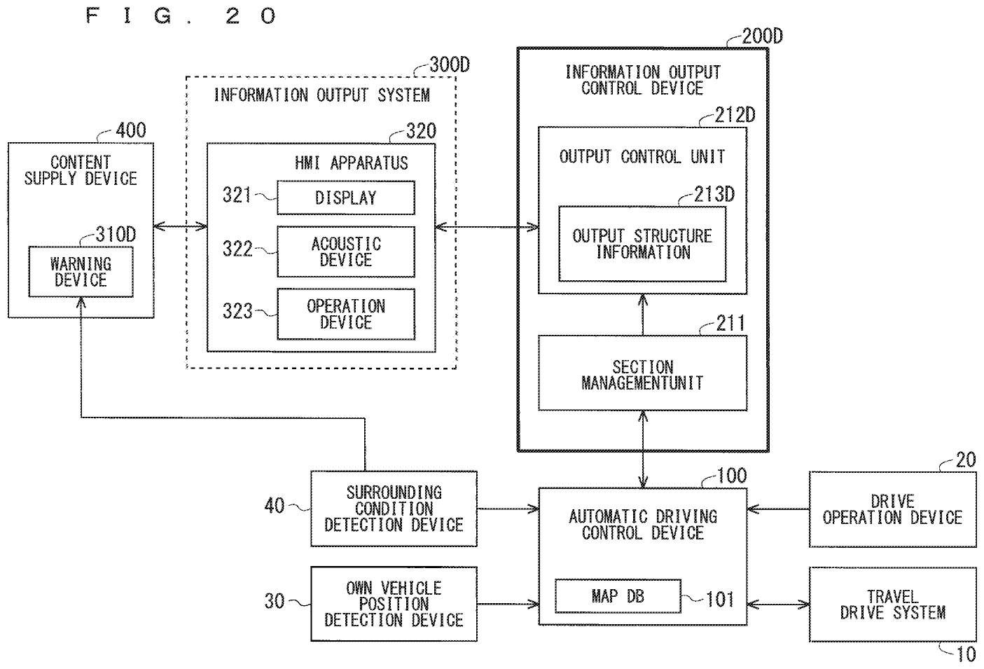

FIGS. 21 and 22 show contents of the output structure information 213D. The contents of the output structure information 213D, however, are not limited to the examples shown in FIGS. 21 and 22.

FIG. 21 defines the allowed output structure and the not-allowed output structure in the basic section, which is set by the automatic driving level, like FIG. 4. Additional to the contents of FIG. 4, FIG. 21 further defines three types of output information, i.e., the entertainment information, traffic information (traffic jam information and the like), and route guidance. Further, information useful for travelling, such as the traffic information and the route guidance, is sometimes referred to as travel support information. Herein, for the entertainment information, the output destination device includes the display 321 and the acoustic device 322 and the output format is a combination of display and audio. For the traffic information and the route guidance, similarly, the output destination device includes the display 321 and the acoustic device 322 and the output format is a combination of display and audio. Further, under the constitution shown in FIG. 21, the output destination device for the warning by display is the display 321 and the output destination device for the warning by audio is the acoustic device 322.

The rule of FIG. 21 is based on the notion that in the automatic driving levels LV0, LV1A, LV1B, and LV2 in which the driver has the driving authority, providing the driver with the entertainment information should be restricted. Further, the rule of FIG. 21 is based on the notion that in the automatic driving level LV34 in which the vehicle has the driving authority, it is not necessary to output the traffic information and the route guidance provided by the navigation system.

FIG. 22 defines whether each of the seven types of output structures shown in FIG. 21 is allowed or not in the change preparation section.

According to FIGS. 21 and 22, the allowed output structures for the change preparation section are defined to include part of the not-allowed output structures for the main section before the change preparation section. Moreover, the allowed output structures for the change preparation section are defined to include at least part of the allowed output structures for the basic section following the change preparation section.

The output control unit 212D controls the display 321 and the acoustic device 322 of the HMI apparatus 320 to perform the information output in the current section to the user in accordance with the allowed output structures for the current section on the basis of the output structure information 213D.

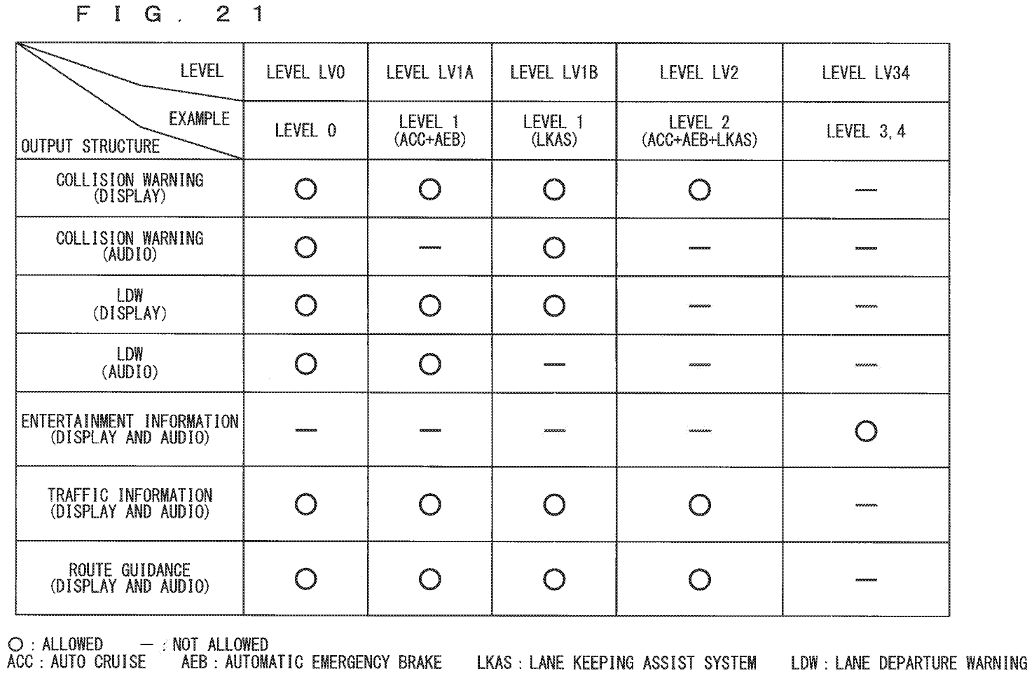

FIGS. 23 to 25 each show exemplary information output in the case where the automatic driving level decreases from LV34 to LV0. In FIGS. 23 to 25, as the display 321, provided are a liquid crystal display 321a in front of the driver's seat and an HUD 321b using the windshield.

FIG. 23 shows a case of the automatic driving level LV34. According to FIG. 23, a video image 501 of the entertainment information is displayed on the liquid crystal display 321a and a voice 502 of the entertainment information is outputted from the acoustic device 322. In this case, the output destination devices of the entertainment information are the liquid crystal display 321a and the acoustic device 322. On the other hand, nothing is displayed on the HUD 321b.

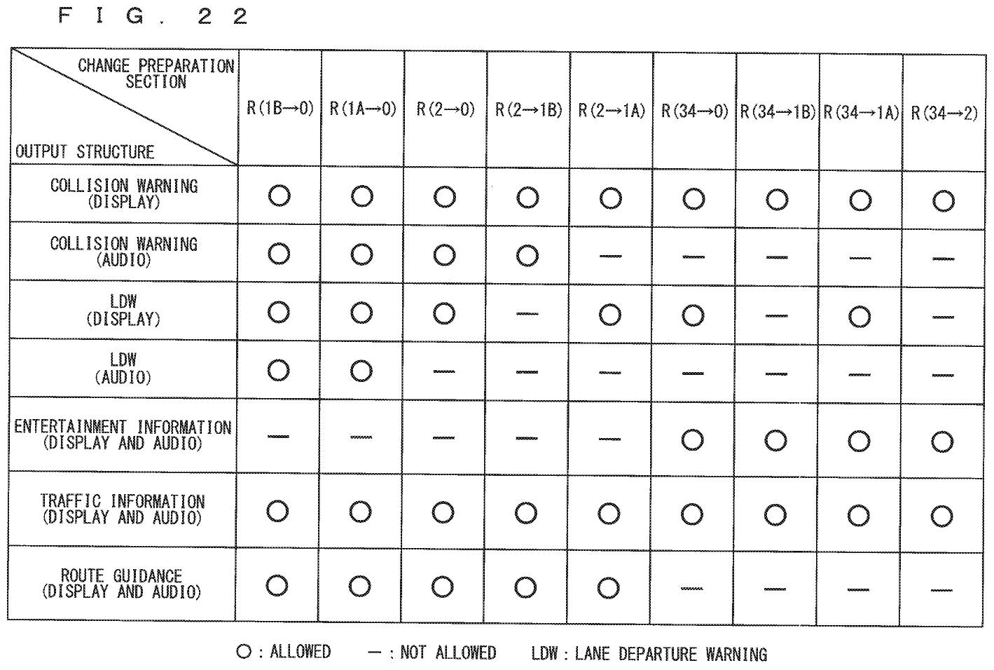

FIG. 24 shows the change preparation section R(34→0) in the case where the automatic driving level decreases from LV34 to LV0. According to FIG. 24, a video image 501 of the entertainment information is displayed on the liquid crystal display 321a and a voice 502 of the entertainment information is outputted from the acoustic device 322.

Further, on the liquid crystal display 321a, displayed is a character message 511 of the traffic information which is supplied from the navigation system. In this case, for the traffic information, the output destination device is the liquid crystal display 321a and the output format is display. Further, concurrently with the character message 511, a voice message of the traffic information may be outputted from the acoustic device 322. In that case, for the traffic information, the output destination devices are the liquid crystal display 321a and the acoustic device 322, and the output format is a combination of display and audio.

Furthermore, on the HUD 321b, displayed is a visual guidance object 521 for the collision warning. In this case, for the collision warning, the output destination device is the HUD 321b and the output format is visual guidance.

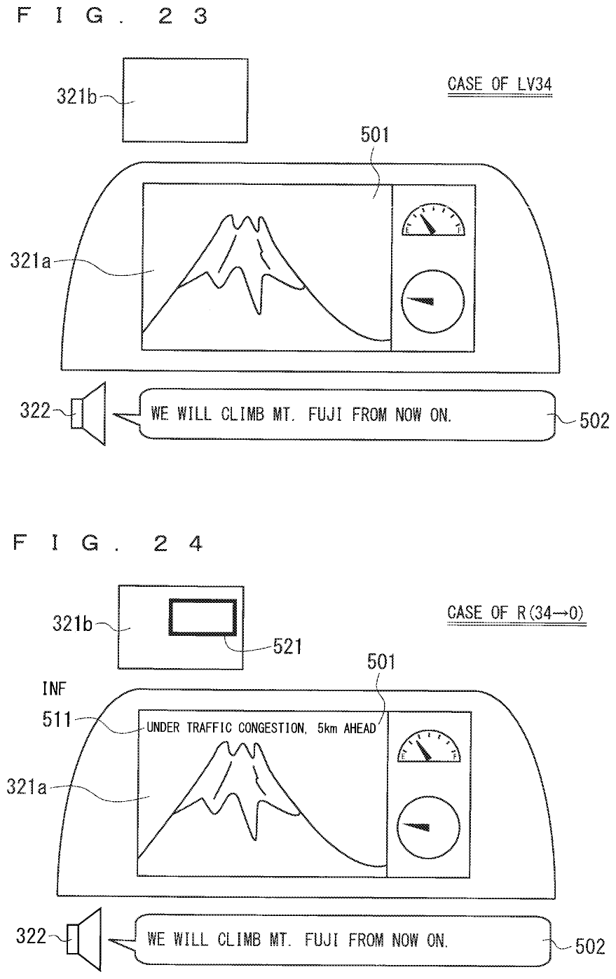

FIG. 25 shows a case of the automatic driving level LV0 after the change preparation section R(34→0). According to FIG. 25, a map 531 and an image message 541 of the route guidance which are supplied from the navigation system are displayed on the liquid crystal display 321a. From the acoustic device 322, a voice message 542 corresponding to the image message 541 is outputted. In this case, for the route guidance, the output destination devices are the liquid crystal display 321a and the acoustic device 322, and the output format is a combination of display and audio.

Further, on the liquid crystal display 321a, displayed is the character message 511 of the traffic information. In this case, for the traffic information, the output destination device is the liquid crystal display 321a and the output format is display. Furthermore, in FIG. 25, since a display area for the character message 511 is small, the character message 511 is displayed, flowing in the display area.

Further, like in FIG. 24, on the HUD 321b, displayed is the visual guidance object 521 for the collision warning.

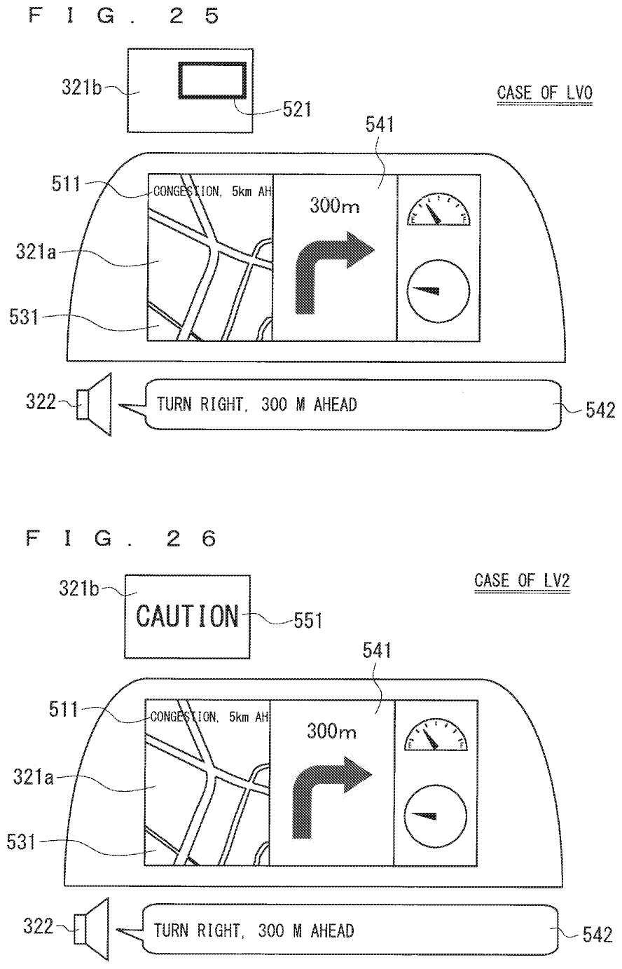

FIGS. 26 to 28 each show exemplary information output in the case where the automatic driving level decreases from LV2 to LV0. Also in FIGS. 26 to 28, as the display 321, provided are the liquid crystal display 321a and the HUD 321b.

FIG. 26 shows a case of the automatic driving level LV2. According to FIG. 26, the respective outputs of the liquid crystal display 321a and the acoustic device 322 are the same as those in FIG. 25. On the HUD 321b, displayed is a character message 551 for the collision warning. In this case, for the collision warning, the output destination device is the HUD 321b and the output format is display.

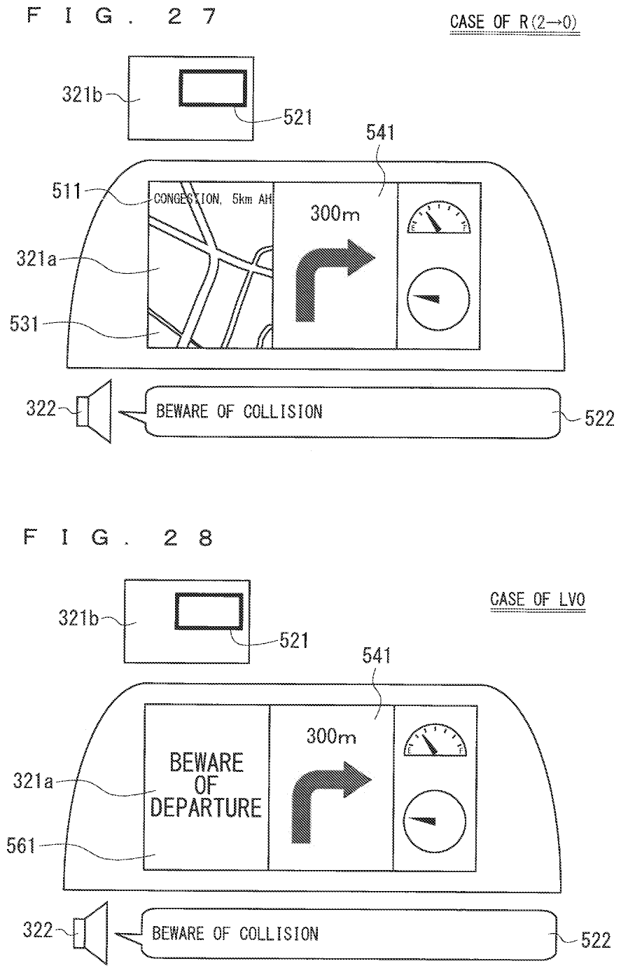

FIG. 27 shows the change preparation section R(2→0) in the case where the automatic driving level decreases from LV2 to LV0. According to FIG. 27, the output of the liquid crystal display 321a is the same as that in FIG. 26. From the acoustic device 322, a voice message 522 for the collision warning is outputted. On the HUD 321b, displayed is the visual guidance object 521 for the collision warning. In this case, since the collision warning by audio and the collision warning by display are outputted at the same time, the output format for the collision warning is a combination of display and audio.

FIG. 28 shows a case of the automatic driving level LV0 after the change preparation section R(2→0). According to FIG. 28, on the liquid crystal display 321a, displayed are a character message 561 for the lane departure warning and the image message 541 of the route guidance. In this case, for the lane departure warning, the output destination device is the liquid crystal display 321a and the output format is display. The same applies to the route guidance. Further, since it is thought that the lane departure warning is more urgent than the route guidance map and the traffic information, in FIG. 28, instead of the map 531 of the route guidance and the character message 511 of the traffic information, the character message 561 for the lane departure warning is displayed. The respective outputs of the acoustic device 322 and the HUD 321b are the same as those in FIG. 27.

The output information is not limited to the examples shown in FIGS. 23 to 28. Specifically, there is a possible case where the collision warning on the rear side of the vehicle is outputted by displaying a rear-side image captured by the vehicle-mounted camera entirely on the liquid crystal display 321a.

Herein, in the case where a plurality of displays are provided, as shown in FIGS. 23 to 28, the output structure can be defined to change the output destination device in accordance with the automatic driving level even when the output information is the same. There may be a case, for example, where while the information generated by the in-vehicle information system is displayed on the display arranged in the center console between the front of the driver's seat and the front of the passenger's seat in the case of the automatic driving level LV34, the same information is displayed on the HUD in the automatic driving level of LV2 or lower. Further, in a plurality of automatic driving levels of LV2 or lower, the same warning may be outputted separately by two types of output destination devices, i.e., the HUD and a vibration device arranged on the steering wheel.

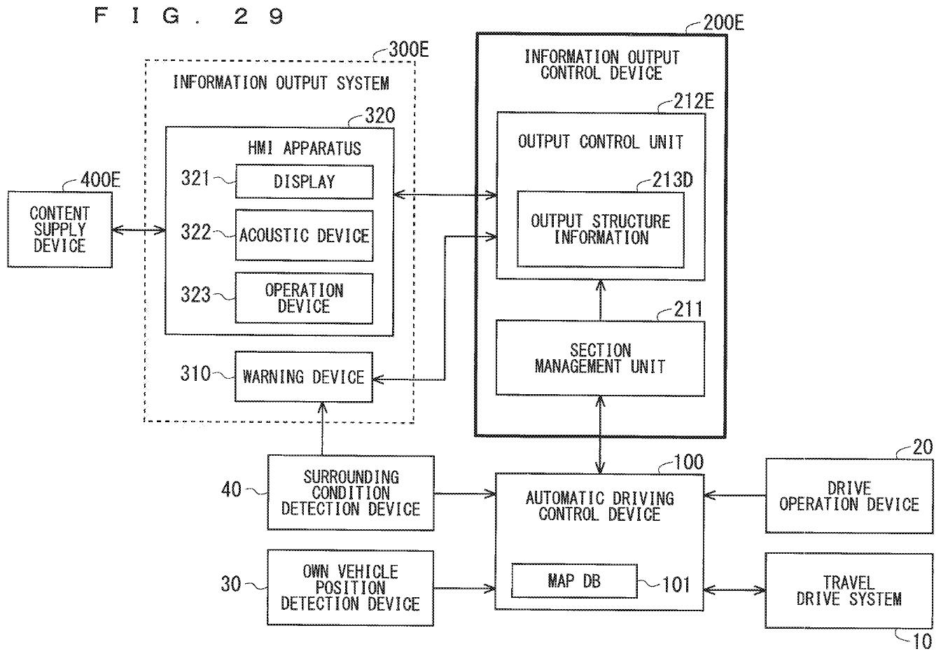

Further, as shown in FIG. 29, the already-described warning device 310 can be used. In this case, a content supply device 400E has a constitution in which the warning device 310D is omitted from the above-described content supply device 400. Further, together with the HMI apparatus 320, the warning device 310 is included in an information output system 300E. An output control unit 212E of an information output control device 200E controls actual outputs of the warning device 310 and the HMI apparatus 320 on the basis of the output structure information 213D.

According to the fifth preferred embodiment, the same effects as those in the first preferred embodiment can be produced.

### The Sixth Preferred Embodiment

In the fifth preferred embodiment, the HMI apparatus 320 acquires the content data from the content supply device 400, and the information output control device 200D controls the use of the acquired content data. In contrast to this, there may be a case where the information output control device acquires the content data from the content supply device and selectively supplies the content data to be used to the HMI apparatus. The sixth preferred embodiment shows such an exemplary case.

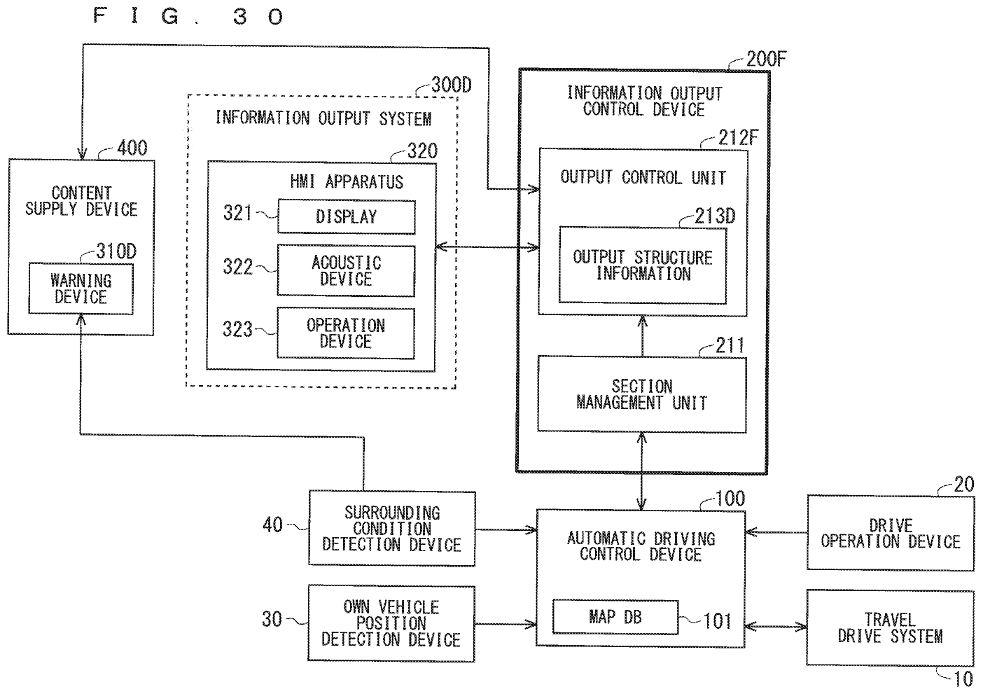

FIG. 30 is a block diagram showing an information output control device 200F in accordance with the sixth preferred embodiment and an application example of the information output control device 200F. As shown in FIG. 30, the content supply device 400 is connected to the information output control device 200F. Further, the content supply device 400 is connected to the information output control device 200F through the external IF 223 for the content supply device 400 as necessary. Furthermore, in the exemplary case shown in FIG. 30, the content supply device 400 is not connected to the information output system 300D.

An output control unit 212F of the information output control device 200F generates output data by selectively using the data in conformity with the allowed output structures for the current section among the content data supplied from the content supply device 400, and supplies the output data to the information output system 300D. The contents selected by the output control unit 212F are thereby outputted by the display 321 and the acoustic device 322.

Herein, the content supply device 400 may be connected to the HMI apparatus 320. In this case, generation of the output contents can be shared by the information output control device 200F and the HMI apparatus 320. For example, the output data of the entertainment information and the route guidance are generated by the HMI apparatus 320 and the output data of the traffic information and the warning are generated by the information output control device 200F.

Further, the constitution in accordance with the sixth preferred embodiment can be modified by following the constitution of FIG. 29 described in the fifth preferred embodiment.

According to the sixth preferred embodiment, the same effects as those in the first preferred embodiment can be produced.

### The Seventh Preferred Embodiment

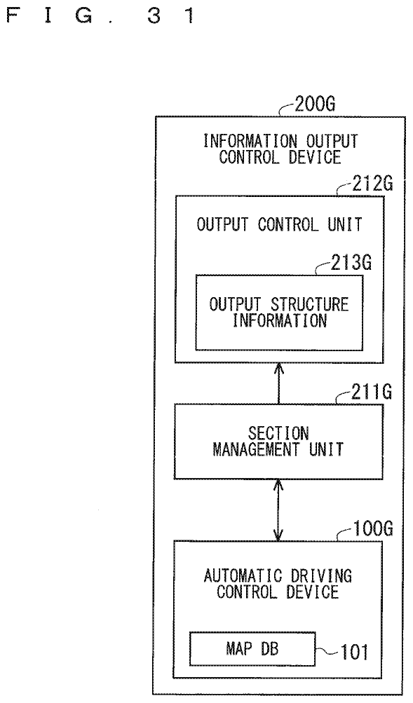

FIG. 31 is a block diagram showing an information output control device 200G in accordance with the seventh preferred embodiment. The information output control device 200G includes a section management unit 211G, an output control unit 212G, output structure information 213G, and an automatic driving control device 100G. The section management unit 211G is formed of any one of the section management units described in the first to sixth preferred embodiments. The output control unit 212G is formed of any one of the output control units described in the first to sixth preferred embodiments. The output structure information 213G is formed of any one of the output structure information described in the first to sixth preferred embodiments. The automatic driving control device 100G is formed of any one of the automatic driving control devices described in the first to sixth preferred embodiments.

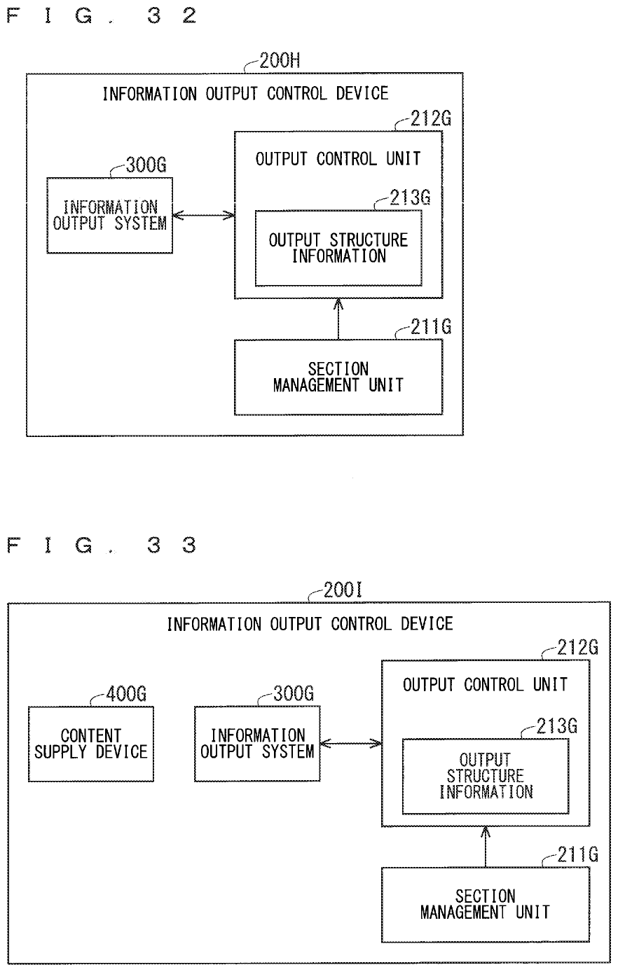

FIG. 32 is a block diagram showing another information output control device 200H in accordance with the seventh preferred embodiment. The information output control device 200H includes the section management unit 211G, the output control unit 212G, the output structure information 213G, and an information output system 300G. The information output system 300G is formed of any one of the information output systems described in the first to sixth preferred embodiments.

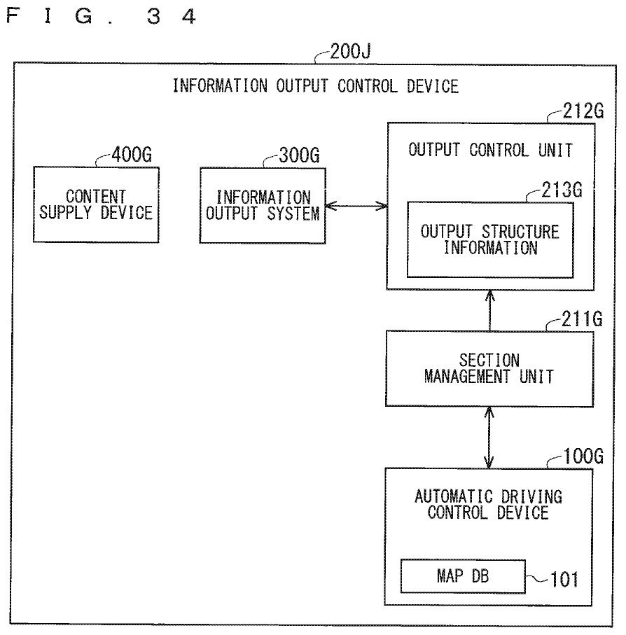

FIG. 33 is a block diagram showing still another information output control device 200I in accordance with the seventh preferred embodiment. The information output control device 200I includes the section management unit 211G, the output control unit 212G, the output structure information 213G, the information output system 300G, and a content supply device 400G. The content supply device 400G is formed of any one of the content supply devices described in the first to sixth preferred embodiments.

Further, in FIG. 33, connection of the content supply device 400G in the information output control device 200I is not shown. In a case with reference to FIG. 20, the content supply device 400G is connected to the information output system 300G. In a case with reference to FIG. 30, the content supply device 400G is connected to the output control unit 212G. Furthermore, the content supply device 400G may be connected to both the information output system 300G and the output control unit 212G.

FIG. 34 is a block diagram showing an information output control device 200J in accordance with the seventh preferred embodiment. The information output control device 20W has a constitution in which the automatic driving control device 100G is added to the information output control device 200I of FIG. 33.

According to the seventh preferred embodiment, the same effects as those in the first preferred embodiment and the like can be produced.

<Variations>

In the above-described description, it is assumed that the information output control device 200 and the like are provided in a vehicle. In contrast to this, part or all of the functions of the information output control device 200 and the like may be implemented by at least one of an information terminal carried inside the vehicle and a server on the internet. The information terminal is a personal computer, a smartphone, or the like. Similarly, part or all of the output structure information 213 and the like may be stored in at least one of the information terminal carried inside the vehicle and the server on the internet. Herein, when the server on the internet is used, access to the server may be made by using a communication function of the information terminal. According to these variations, the same effects as those in the first preferred embodiment and the like can be produced.

According to the present invention, the above embodiments can be arbitrarily combined, or each embodiment can be appropriately varied or omitted within the scope of the invention.

### EXPLANATION OF REFERENCE SIGNS

1 planned travel route, 100, 100B, 100G automatic driving control device, 200, 200C to 200J information output control device, 211, 211C, 211G section management unit, 212, 212D to 212G output control unit, 213, 213D, 213G output structure information, 300, 300D, 300E, 300G information output system, 310, 310D warning device, 311, 312 warning light, 313 acoustic device, 320 HMI apparatus, 321 display, 321a liquid crystal display, 321b HUD, 322 acoustic device, 400, 400E, 400G content supply device, K10 first basic section, K11 main section, K12 change preparation section, K20 second basic section

1-19. (canceled)

20. An information output control device which controls an information output system used for a vehicle capable of traveling by automatic driving, comprising:
a processor to execute a program; and
a memory to store the program which, when executed by the processor, performs processes of,
determining a current section in which the vehicle is present among a plurality of sections set for a planned travel route of the vehicle, and
controlling the information output system so as to perform information output to a user, in accordance with an output structure allowed in the current section, among a plurality of types of output structures determined by a combination of output information, an output format, and an output destination device included in the information output system,
wherein the plurality of sections include:
a first basic section in which the vehicle is planned to travel at a first automatic driving level;
a second basic section in which the vehicle is planned to travel at a second automatic driving level lower than the first automatic driving level;
a change preparation section which is set when the second basic section is continuous to the first basic section, starting during the first basic section and ending at the start of the second basic section; and
a main section which is a section of the first basic section except the change preparation section,
wherein allowed output structures for the change preparation section include part of not-allowed output structures for the main section and also include at least part of allowed output structures for the second basic section.

21. The information output control device according to claim 20, wherein
the number of allowed output structures for the change preparation section increases as the change preparation section approaches an end.

22. The information output control device according to claim 20, wherein
the change preparation section is set in conformity with at least one of
a rule defining that the change preparation section is set to have a fixed length determined in advance;
a rule defining that the change preparation section is set longer as the planned travel route is more crowded;
a rule defining that the change preparation section is set longer as an attention level of a driver of the vehicle is lower; and
a rule defining that the length of the change preparation section is set in accordance with respective values of the first automatic driving level and the second automatic driving level.

23. The information output control device according to claim 20, wherein
the processes include acquiring information on the first basic section, the second basic section, the change preparation section, the main section, and the current section from an automatic driving control device of the vehicle.

24. The information output control device according to claim 20, wherein
the processes include acquiring a travel control plan of the planned travel route from the automatic driving control device of the vehicle and setting the change preparation section on the basis of the travel control plan.

25. The information output control device according to claim 20, wherein
the processes include finishing the change preparation section concurrently with the start of the second automatic driving level when an automatic driving level change instruction to change from the first automatic driving level to the second automatic driving level is received in the change preparation section.

26. The information output control device according to claim 20, wherein
the first automatic driving level is a state in which the vehicle has driving authority,
the second automatic driving level is a state in which a driver of the vehicle has the driving authority,
it is prohibited that the driving authority is moved from the vehicle to the driver in the main section, and
the processes include starting the change preparation section ahead of plan when an automatic driving level change instruction to change from the first automatic driving level to the second automatic driving level is acquired in the main section.

27. The information output control device according to claim 26, wherein
it is permitted that the driving authority is moved from the vehicle to the driver in the change preparation section, and
the processes include causing the information output system to output notification which prompts a reinput of the automatic driving level change instruction after the start of the change preparation section.

28. The information output control device according to claim 20, wherein
the output information includes at least one of active safety warning, travel support information, and information which is limited to provide a driver during driving, and
the output format includes at least one of audio, display, a combination of audio and display, vibration, visual guidance, use of a sound image position.

29. The information output control device according to claim 20, wherein
the output information includes entertainment information and active safety warning,
the entertainment information is allowed to output only in a section in which the vehicle has driving authority of the vehicle, and
the active safety warning is not allowed to output in the section in which the vehicle has the driving authority but is allowed to output in a section in which a driver of the vehicle has the driving authority.

30. The information output control device according to claim 29, wherein
the information output system includes a head up display as the output destination device,
the active safety warning is allowed to be displayed on the head up display, and
the entertainment information is not allowed to be displayed on the head up display.

31. The information output control device according to claim 20, wherein
the output information includes entertainment information and travel support information,
the entertainment information is allowed to output only in a section in which the vehicle has driving authority of the vehicle, and
the travel support information is not allowed to output in the section in which the vehicle has the driving authority but is allowed to output in a section in which a driver of the vehicle has the driving authority.

32. The information output control device according to claim 31, wherein
the information output system includes a head up display as the output destination device, and
the entertainment information is not allowed to be displayed on the head up display.

33. The information output control device according to claim 20, further comprising:
an automatic driving control device of the vehicle.

34. The information output control device according to claim 20, further comprising:
the information output system.

35. The information output control device according to claim 34, further comprising:
a content supply device to supply content data of the output information.

36. The information output control device according to claim 20, wherein
the processes include controlling the information output system so as to selectively use data in conformity with the allowed output structures for the current section, among content data acquired from a content supply device.

37. The information output control device according to claim 20, wherein
the processes include acquiring content data form a content supply device, selectively using data in conformity with the allowed output structures for the current section among the content data to generate output data, and supplying the output data to the information output system.

38. An information output control method for controlling an information output system used for a vehicle capable of traveling by automatic driving, comprising:
determining a current section in which the vehicle is present among a plurality of sections set for a planned travel route of the vehicle,
wherein the plurality of sections include:
a first basic section in which the vehicle is planned to travel at a first automatic driving level;
a second basic section in which the vehicle is planned to travel at a second automatic driving level lower than the first automatic driving level;
a change preparation section which is set when the second basic section is continuous to the first basic section, starting during the first basic section and ending at the start of the second basic section; and
a main section which is a section of the first basic section except the change preparation section,
the information output control method further comprising:
controlling the information output system so as to perform information output to a user, in accordance with an output structure allowed in the current section, among a plurality of types of output structures determined by a combination of output information, an output format, and an output destination device included in the information output system,
wherein allowed output structures for the change preparation section include part of not-allowed output structures for the main section and also include at least part of allowed output structures for the second basic section.
